(19) United States
(12) Patent Application Publication
(10) Pub. No.: US 2005/0125689 A1
(43) Pub. Date: Jun. 9, 2005

(54) Processing device security management and configuration system and user interface

(76) Inventor: Domonic Snyder, Whitehall, PA (US)

Correspondence Address: Alexander J. Burke;Intellectual Property Department, 5th Floor, 170 Wood Avenue South, Iselin, NJ, 08830, US

(21) Appl. No.: 10/944,126

(22) Filed: Sep. 17, 2004

Related U.S. Application Data
(60) Provisional application No. 60/503,627, filed on Sep. 17, 2003.

(51) Int. Cl. H04L 9/00

(52) U.S. Cl. 713/200

(57) ABSTRACT

A centralized system, for configuring security settings of different processing devices via network communication, includes a display generator, a communication processor, and a configuration processor. The display generator initiates generation of data representing images including one or more images supporting user selection of data items. The data items include identifiers for identifying different processing devices, an identifier for identifying different websites hosted by corresponding different processing devices, and an identifier for identifying directories of the different websites. The communication processor establishes communication links with the different processing devices via a network. The configuration processor employs the communication links and the data items for initiating setting of security properties of the directories of the different websites in response to a user command.

### CROSS-REFERENCE TO RELATED APPLICATIONS

The present application is a non-provisional application of provisional applications having Ser. Nos. 60/503,240 and 60/503,297 filed by Domonic Snyder on Sep. 16, 2003, and No. 60/503,627 filed by Domonic Snyder on Sep. 17, 2003.

### FIELD OF THE INVENTION

The present invention generally relates to computer information systems. More particularly, the present invention relates to a processing device security management and configuration system and user interface.

### BACKGROUND OF THE INVENTION

The development of computer information systems has created an important class of computers known as servers. A server is a computer or device on a network that manages network resources by providing services, including both computational and data services, to other computers or devices on the network. A server platform is a term often used synonymously with operating system, and provides the underlying hardware and/or software for a system as the engine that drives a server. Various types of servers include, for example, application servers, database servers, audio/video servers, chat servers, fax servers, file transfer protocol (FTP) servers, groupware servers, Internet chat relay (IRC) servers, list servers, mail servers, news servers, proxy servers, Telnet servers, and web servers. Servers are often dedicated, meaning that they perform no other tasks besides their server tasks. On multiprocessing operating systems, however, a single computer can execute several application programs at once. In this case, a server could refer to a particular application program that is managing resources rather than the entire computer.

Because of their service role, it is common for servers to store many of an entity's most valuable and confidential information resources. Servers are also often deployed to provide a centralized capability for an entire organization, such as communication (electronic mail) or user authentication. Security breaches on a server can result in the disclosure of critical information or the loss of a capability that can affect the entire entity. Therefore, securing servers should be a significant part of an entity's network and information security strategy.

Security information management is an emerging area of security management, made necessary by the onslaught of security data generated by disparate physical and information technology (IT) security systems, platforms, and applications. Each of the systems, platforms, and applications may generate information in a different way, present it in a different format, store it in a different place, and report it to a different location. This incessant flood of data (e.g., literally, millions of messages daily) from incompatible security technologies overwhelms a security infrastructure, resulting in security information overload and creating a negative impact on business operations. With no way to manage and integrate information, this fragmented approach often leads to duplication of effort, high overhead, weak security models, and failed audits.

Typically, security information management tools use correlation rules, visualization, and advanced forensics analysis to transform raw security data into actionable business intelligence, facilitating real-time event management or post-event investigation. The tools enable an entity's IT and security staff to visualize network activity and determine how business assets are affected by network exploits, internal data theft, and security or human resource policy violations, and provide the audit trails necessary for regulatory compliance.

Security information management solutions also reduce, aggregate, correlate, and prioritize disparate security data from multiple security devices and software technologies, integrating an entity's physical and IT security environments. Ideally, security information management tools integrate with an entity's most business-critical applications, including accounting, payroll, human resources, and manufacturing, providing security and event management for these vital systems.

When properly implemented, security information management delivers a secure business solution that helps reduce the cost and complexity of event management, increase administrative efficiencies, help ensure regulatory compliance (e.g., ensure patient information is maintained in a secure environment for good practice and Health Insurance Portability and Accountability Act (HIPAA) regulations), and improve a company's overall security posture.

Many security problems can be avoided or minimized, if servers and networks are properly configured for security. However, vendors that set default hardware and software configurations tend to emphasize features and functions more than security. Since vendors are not aware of each entity's security needs, each entity should configure new servers to reflect the entity's security requirements and reconfigure the servers as the entity's requirements change. Further, some servers store security configuration information locally on individual servers, which is retrieved and updated manually.

Disadvantages of present computer information systems in processing security configuration information include, for example, inefficiency, physically logging on to each server to gather configuration information, being error prone, lacking centralized storage of security configuration information, incompatible interfaces, lack of validation of security configuration information, etc. Accordingly, there is a need for a processing device security management and configuration system and user interface that overcomes these and other disadvantages of the prior computer information systems.

In present computer information systems that require manual configuration of individual server's security settings, the following steps, for example, are performed for multiple servers for each customer/user:
1. Create the appropriate local Windows® NT file system (NTFS) groups.
2. Determine the appropriate directories to apply the NTFS groups to.
3. Apply the appropriate security to each of the physical directories.
4. Enable remote secure access (RSA) secure identification (ID) property and IP address restrictions of each virtual directory and sub directory (e.g., three distinct physical directories under a virtual directory).

Disadvantages of present computer information systems requiring manual configuration of individual server's security settings include, for example, time consuming set up, the need to physically log on to each server to perform tasks, error prone manual configuration, and difficult debug operations where an error is made in a redundant environment. Accordingly, there is also a need for a processing device security setting configuration system and user interface that overcomes these and other disadvantages of the prior computer information systems.

### SUMMARY OF THE INVENTION

A centralized system, for configuring security settings of different processing devices via network communication, includes a display generator, a communication processor, and a configuration processor. The display generator initiates generation of data representing images including one or more images supporting user selection of data items. The data items include identifiers for identifying different processing devices, an identifier for identifying different websites hosted by corresponding different processing devices, and an identifier for identifying directories of the different websites. The communication processor establishes communication links with the different processing devices via a network. The configuration processor employs the communication links and the data items for initiating setting of security properties of the directories of the different websites in response to a user command.

### BRIEF DESCRIPTION OF THE DRAWINGS

FIG. 1 illustrates a block diagram of a computer information system, in accordance with a preferred embodiment of the present invention.

FIG. 2 illustrates a block diagram of a net access security system implemented with the computer information system, as shown in FIG. 1, in accordance with a preferred embodiment of the present invention.

FIG. 3 illustrates a security management system window implemented with the net access security system, as shown in FIG. 2, in accordance with a preferred embodiment of the present invention.

FIG. 4 illustrates a server window implemented with the net access security system, as shown in FIG. 2, in accordance with a preferred embodiment of the present invention.

FIG. 5 illustrates a remote secure access (RSA) window implemented with the net access security system, as shown in FIG. 2, in accordance with a preferred embodiment of the present invention.

FIG. 6 illustrates an Internet Protocol (IP) addresses window implemented with the net access security system, as shown in FIG. 2, in accordance with a preferred embodiment of the present invention.

FIG. 7 illustrates an add single IP address window implemented with the net access security system, as shown in FIG. 2, in accordance with a preferred embodiment of the present invention.

FIG. 8 illustrates an add a range of IP addresses window implemented with the net access security system, as shown in FIG. 2, in accordance with a preferred embodiment of the present invention.

FIG. 9 illustrates an import a range of IP addresses window implemented with the net access security system, as shown in FIG. 2, in accordance with a preferred embodiment of the present invention.

FIG. 10 illustrates a default servers window implemented with the net access security system, as shown in FIG. 2, in accordance with a preferred embodiment of the present invention.

FIG. 11 illustrates a default IP addresses window implemented with the net access security system, as shown in FIG. 2, in accordance with a preferred embodiment of the present invention.

FIG. 12 illustrates a connectivity communication window implemented with the net access security system, as shown in FIG. 2, in accordance with a preferred embodiment of the present invention.

FIG. 13 illustrates a connectivity testing window implemented with the net access security system, as shown in FIG. 2, in accordance with a preferred embodiment of the present invention.

FIG. 14 illustrates an initialize a new server window implemented with the net access security system, as shown in FIG. 2, in accordance with a preferred embodiment of the present invention.

FIG. 15 illustrates a refresh all servers window implemented with the net access security system, as shown in FIG. 2, in accordance with a preferred embodiment of the present invention.

FIG. 16 illustrates an add a default server method implemented with the net access security system, as shown in FIG. 2, in accordance with a preferred embodiment of the present invention.

FIG. 17 illustrates a remove a default server method implemented with the net access security system, as shown in FIG. 2, in accordance with a preferred embodiment of the present invention.

FIG. 18 illustrates an enable a default server method implemented with the net access security system, as shown in FIG. 2, in accordance with a preferred embodiment of the present invention.

FIG. 19 illustrates an add default IP restrictions method implemented with the net access security system, as shown in FIG. 2, in accordance with a preferred embodiment of the present invention.

FIG. 20 illustrates a remove default IP restrictions method implemented with the net access security system, as shown in FIG. 2, in accordance with a preferred embodiment of the present invention.

FIG. 21 illustrates an enable default IP restrictions method implemented with the net access security system, as shown in FIG. 2, in accordance with a preferred embodiment of the present invention.

FIG. 22 illustrates an edit default IP restrictions method implemented with the net access security system, as shown in FIG. 2, in accordance with a preferred embodiment of the present invention.

FIG. 23 illustrates an initialize a new server method implemented with the net access security system, as shown in FIG. 2, in accordance with a preferred embodiment of the present invention.

FIG. 24 illustrates a refresh servers method implemented with the net access security system, as shown in FIG. 2, in accordance with a preferred embodiment of the present invention.

FIG. 25 illustrates an apply configurations method implemented with the net access security system, as shown in FIG. 2, in accordance with a preferred embodiment of the present invention.

FIG. 26 illustrates an RSA Security method 2600 implemented with the net access security system, as shown in FIG. 2, in accordance with a preferred embodiment of the present invention.

FIG. 27 illustrates an IP Security method 2700 implemented with the net access security system, as shown in FIG. 2, in accordance with a preferred embodiment of the present invention.

### DETAILED DESCRIPTION OF THE PREFERRED EMBODIMENTS

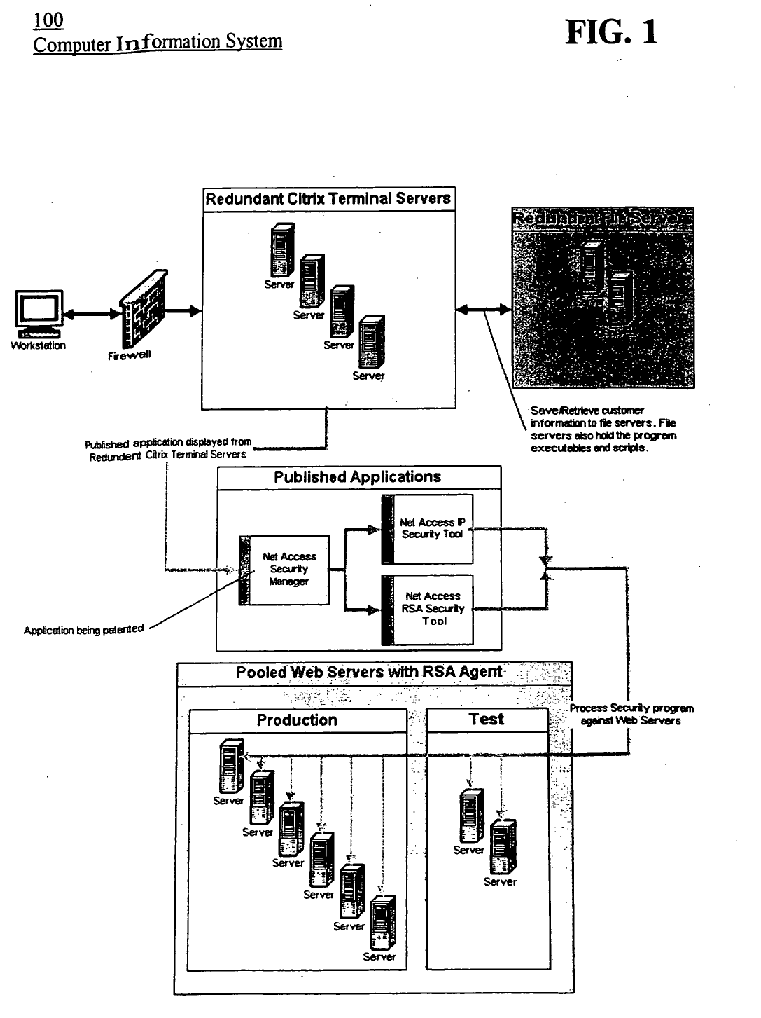

FIG. 1 illustrates a block diagram of a computer information system (“system”) 100. The system 100 includes a computer 101, a firewall 102, redundant terminal servers 103, redundant file servers 104, a net access security system 105, and pooled web servers 106. The net access security system 105 (“security system”) are published applications that further includes a net access security manager 107, a net access Internet Protocol (IP) security tool 108, and a net access remote secure access (RSA) security tool 109. Publishing the applications advantageously permits central management of the code used to perform the security management functions. The pooled web servers 106 further include production servers 110 and test servers 111.

The firewall 102 provides security between the workstation 101 and the redundant terminal servers 103. The redundant terminal servers 103 save and retrieve customer information to and from, respectively, the redundant file servers 104, which stores application programs and scripts. The redundant terminal servers 103 publish the security systems 105, which process security information for the pooled web servers 106.

Various aspects of the present invention related to each of the security system 105, including the net access security manager 107, the net access IP security tool 108, and the net access RSA security tool 109. The security system 105 advantageously enable entities to manage security configuration information, whatever its source, type, or location, from a single, centralized location to increase security, order, and efficiency of the system 100.

Users of an entity or organization access the security system 105 published on redundant desktop personal computers (PCs) 101 on Citrix terminal servers 103, for example, located on a user network. The physical data files are located on a clustered file stored in the redundant file servers 104. Links are set up on the support desktop PCs 101 to launch the security system 105 from the location stored in the redundant file servers 104.

Any type of enterprise or organization system 100 may employ the system 100, and is preferably intended for use by providers of healthcare products or services responsible for servicing the health and/or welfare of people in its care. A healthcare provider may provide services directed to the mental, emotional, or physical well being of a patient. Examples of healthcare providers include a hospital, a nursing home, an assisted living care arrangement, a home health care arrangement, a hospice arrangement, a critical care arrangement, a health care clinic, a physical therapy clinic, a chiropractic clinic, a medical supplier, a pharmacy, and a dental office. When servicing a person in its care, a healthcare provider diagnoses a condition or disease, and recommends a course of treatment to cure the condition, if such treatment exists, or provides preventative healthcare services. Examples of the people being serviced by a healthcare provider include a patient, a resident, a client, a user, and an individual.

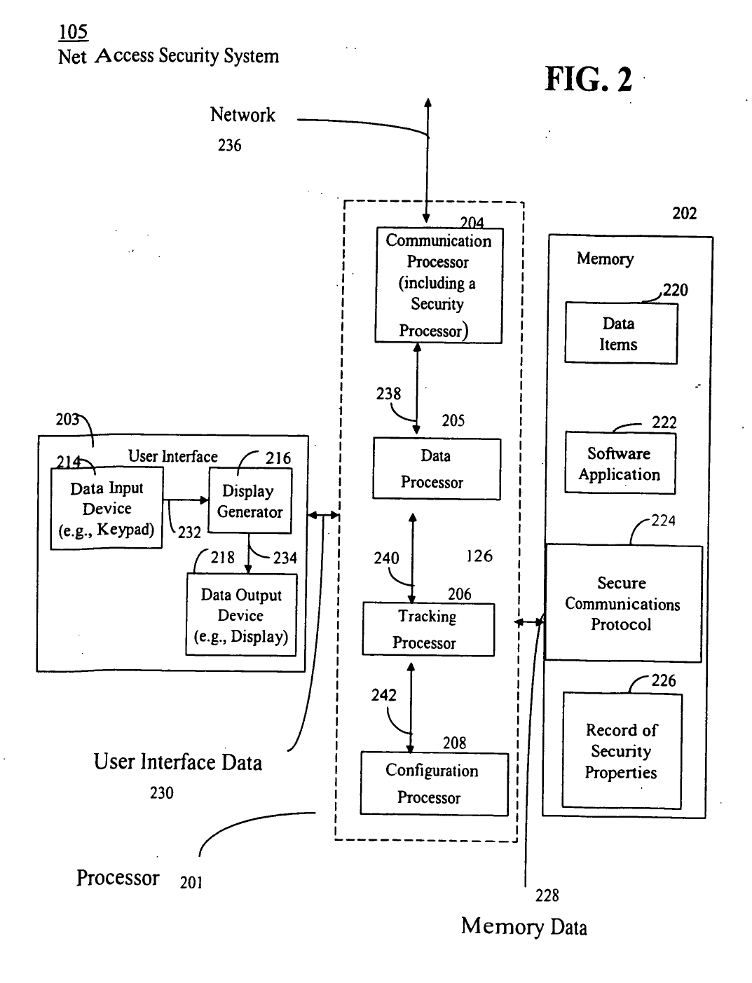

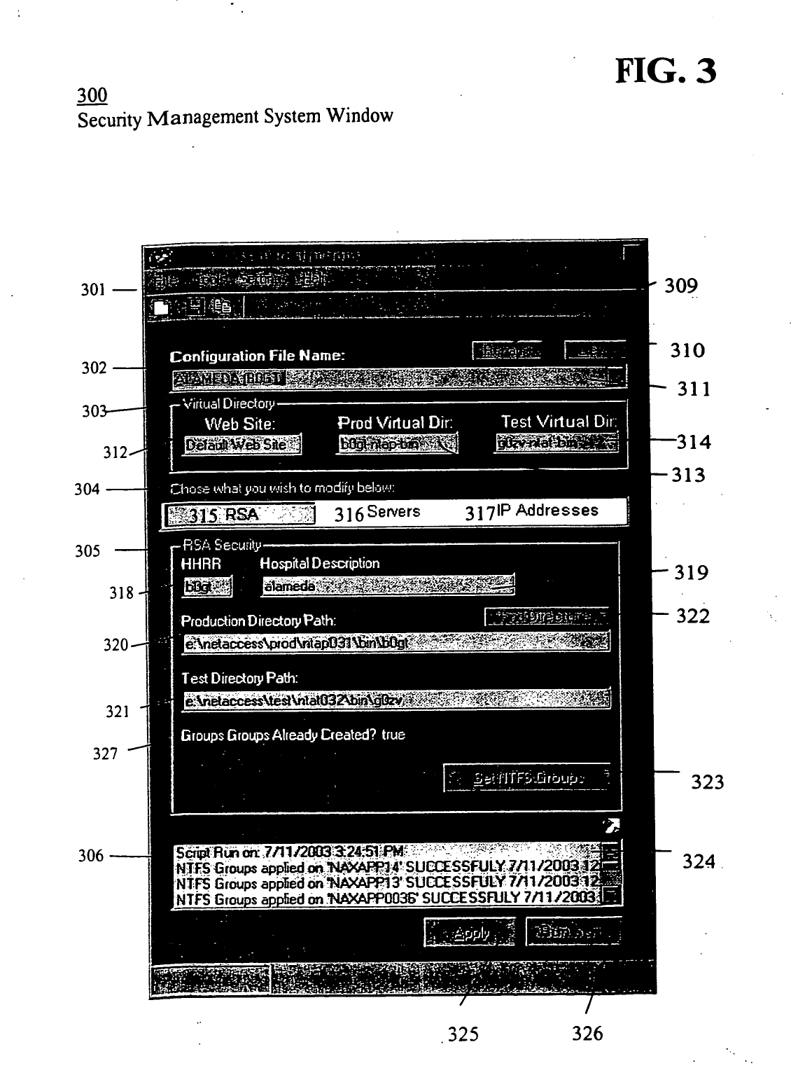

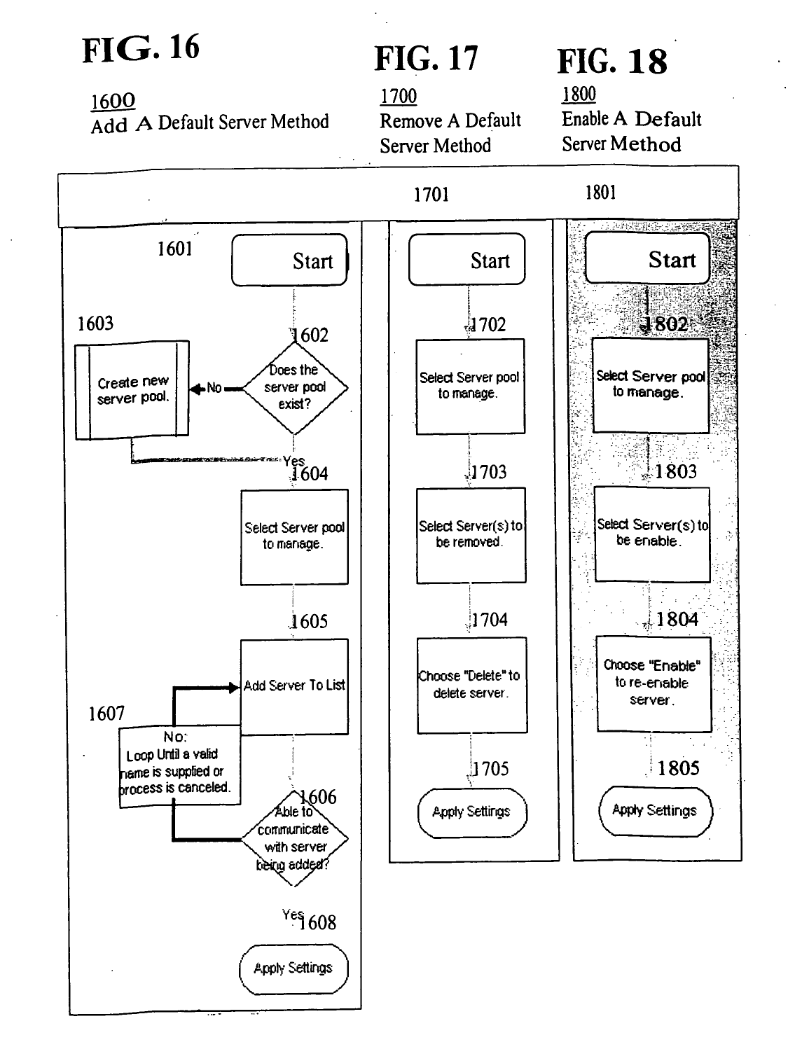

FIG. 2 illustrates a block diagram of a net access security system (“security system”) 105 implemented with the system 100, as shown in FIG. 1. The security system 105 provides a centralized system for configuring security settings of multiple different processing devices via network communication. The security system 105 employs user interface windows, as illustrated in FIGS. 3 to 15, and methods, as illustrated in FIGS. 16 to 27.

The security system 105 includes a processor 201, a memory 202, and a user interface 203 (otherwise called an “interface processor”). The processor 201 further includes a communication processor 204, a data processor 205, a tracking processor 206, and a configuration processor 208. The communication processor 204 further includes a security processor. The memory 202 further includes data items 220, a software application 222, a secure communications protocol 224, and a record of security properties 226. The user interface 203 further includes a data input device 214, a display generator 216, and a data output device 218.

The communication processor 204 represents any type of communication interface that establishes communication links, by sending and/or receiving any type of signal, such as data, representing security configuration information, with the multiple different processing devices via a network 236. The multiple different processing devices comprise one or more of: (a) multiple different servers, (b) multiple different computers, and (c) multiple portable processing devices.

The communication processor 204 establishes the communication links using a secure communication protocol 224 stored in the memory 202. The secure server communication protocol 224 includes one or more of: (a) Active Directory Service Interface (ADSI) compatible protocol, (b) Secure Socket Layer (SSL) compatible protocol, (c) Lightweight Directory Access Protocol (LDAP), (d) RSA-security compatible protocol, and (e) Microsoft windows management instrumentation (WMI) compatible protocol.

The communication processor 204 includes a security processor for initiating access to security settings associated with a directory using an identifier identifying a particular processing device of the multiple different processing devices, an identifier identifying a particular website, of the multiple different websites, hosted by the particular processing device, and an identifier identifying a directory of the particular website.

The communication processor 204 uses the secure communication link for determining an access path including one or more of: (a) a communication path, and (b) an address of a physical stored file containing the directory. In this case, the configuration processor 208 associates a label with the access path, wherein the label identifying a group of users.

The data processor 205 examines a predetermined list identifying websites and directories, associated with corresponding processing devices, to identify a processing device having the particular directory.

The tracking processor 206 maintains a record of one or more of: (a) user identifiers, and (b) changes in security settings, supporting providing an audit trail identifying security setting changes and associated users.

The configuration processor 208 employs the communication links and the data items for initiating setting of security properties of one or more directories of one or more websites hosted by a particular processing device, preferably in response to user command from the user interface 203. The configuration processor 208 also employs the communication links and the data items 220 for setting security properties of one or more directories of the website(s) hosted by one or more of the corresponding multiple different processing devices in response to user command. The configuration processor 208 also stores a record of the set security properties 226 of the directories in the memory 202.

The configuration processor 208 sets the security properties of the directory by one or more of: (a) replacing existing settings with new settings, and (b) establishing new settings. The configuration processor 208 employs RSA-security compatible protocol to restrict user access to a user within a predetermined group of users. The configuration processor 208 sets security properties of the directories of the multiple different websites, hosted by the corresponding multiple different processing devices, to the same settings.

The configuration processor 208 adaptively initiates setting of multiple different types of security properties of the directories by a corresponding multiple different security setting processes. The multiple different types of security properties are used to one or more of: (a) restrict user access to a particular Internet Protocol (IP) compatible address or address range, (b) restrict user access to a user within a predetermined group of users, and (c) restrict user access to a user within predetermined multiple groups of users.

The configuration processor 208 sets security properties of the directories of the multiple different websites hosted by the corresponding multiple different processing devices, to settings of a directory of a web site hosted by a particular processing device and imported from the particular processing device.

The configuration processor 208 uses a first communication protocol for establishing a path to the directory, and uses a different second communication protocol for communicating setting information to the particular processing device. The first and second communication protocols include one or more the secure server communication protocols 224 described herein.

The memory 202 represents a data storage element and may otherwise be called a repository, a storage device, a database, etc. The database may be of any type including for example, a Microsoft® (MS) Access® database, or a sequel (SQL) database. The memory 202 stores the data items 220, the software application 222, the secure communications protocol 224, and the record of security properties 226, which are communicated by the processor 201 as memory data 228.

The data items 220 include, for example: identifiers for identifying multiple different processing devices, an identifier identifying multiple different websites hosted by corresponding multiple different processing devices, and an identifier for identifying directories of the multiple different websites. A directory comprises an index identifying documents associated with a web site. The directories of the multiple different websites are one or more of: (a) virtual directories, and (b) physical file directories having a physical storage location.

The data items 220 received by the communication processor 204 include security settings including one or more of: (a) an Internet Protocol (IP) compatible address, (b) an identifier identifying a predetermined group of users, (c) an identifier identifying an individual user of a group of users, and (d) multiple identifiers identifying corresponding users associated with a particular group.

The security system 105 incorporates two executable applications, stored as the software application 222, in the memory 202. A first executable application (e.g., for the security manager 107) collects and validates information required, and provides this information to a second executable application (e.g., for the IP security tool 108 and/or the RSA security tool 109) for configuring and managing security. However, the number of executable applications involved is arbitrary. A single executable application or multiple executable applications (e.g., two or more) may be used to implement the functions described herein.

The user interface 203 permits a user to interact with the security system 105 by inputting data into the security system 105 and/or receiving data from the security system 105. The user interface 203 generates one or more display images, as shown in FIGS. 3 to 15, for example.

The data input device 214 provides input data 232 to the display generator 216 in response to receiving input information either manually from a user or automatically from an electronic device. The data input device 214 is a keyboard, but also may be a touch screen, or a microphone with a voice recognition application, for example.

The display generator 216 generates display signals 234, representing one or more images for display, in response to receiving the input data 232 or other data from the security system 105, such as the user interface data 230 from the processor 201. The one or more display images include one or more images supporting user selection of the data items 220 stored in the memory 202.

The display generator 216 is a known element including electronic circuitry or software or a combination of both for generating display images or portions thereof. The image for display may include any information stored in the memory 202 and any information described herein. An action by a user, such as, for example, an activation of a displayed button, may cause the image to be displayed.

At least one image supports user selection of security properties of the directories, which restricts access to one or more of: (a) the directories, and (b) an individual one of the multiple documents identified in a directory. The security properties also restrict access to one or more of: (a) a user at a particular Internet Protocol (IP) compatible address, (b) a user having an IP compatible address within a predetermined range of IP addresses, and (c) a particular user within a predetermined group of users.

At least one image on the display generator 216 supports user selection of one or more of: (a) a name associated with configuration parameters of a particular user, (b) an identifier identifying a predetermined list of processing devices including the multiple different processing devices, and (c) the security properties.

At least one image displays an alert message in response to one or more of: (a) a failure to establish a communication link with a particular processing device of the multiple different processing devices, (b) a failure to identify a particular website, of the multiple different websites, hosted by the particular processing device, and (c) a failure to identify a directory of the particular website.

At least one image supports user selection of the data items 220, including identifiers for identifying multiple different processing devices based on user selection of the multiple different processing devices from at least one predetermined list of processing devices.

The data output device 218 represents any type of element that reproduces data for access by a user. The data output device 218 is a display that generates display images, as shown in FIGS. 3 to 15, in response to receiving the display signals 134, but also may be a speaker or a printer, for example.

The user interface 203 provides a graphical user interface (GUI), as shown in FIGS. 3 to 15, for example, wherein portions of the data input device 214 and portions of the data output device 218 are integrated together to provide a user-friendly interface. The GUI may have any type of format, layout, user interaction, etc., as desired, and should not be limited to that shown in FIGS. 3 to 15. The GUI may also be formed as a web browser (not shown).

In the security system 105, one or more elements may be implemented in hardware, software, or a combination of both. Further, one or more elements may include one or more processors, collectively represented as processor 201, such as the communication processor 204, the data processor 205, the tracking processor 206, and the configuration processor 208, as well as the display generator 216. A processor includes any combination of hardware, firmware, and/or software. A processor acts upon stored and/or received information by computing, manipulating, analyzing, modifying, converting, or transmitting information for use by an executable procedure or an information device, and/or by routing the information to an output device. For example, a processor may use or include the capabilities of a controller or microprocessor.

A processor performs tasks in response to processing an object. An object comprises a grouping of data and/or executable instructions, an executable procedure, or an executable application. An executable application comprises code or machine readable instruction for implementing predetermined functions including those of an operating system, healthcare information system, or other information processing system, for example, in response user command or input.

The security system 105 may be fixed or mobile (i.e., portable), and may be implemented in a variety of forms including a personal computer (PC), a desktop computer, a laptop computer, a workstation, a minicomputer, a mainframe, a supercomputer, a network-based device, a personal digital assistant (PDA), a smart card, a cellular telephone, a pager, and a wristwatch. The system 100 may be implemented in a centralized or decentralized configuration.

The security system 105 in FIG. 1 provides for security configuration information to be communicated to and from the pooled web servers 106. The security configuration information may be represented in any file format including numeric files, text files, graphic files, video files, audio files, and visual files. The graphic files include a graphical trace including, for example, an electrocardiogram (ECG) trace, and an electroencephalogram (EEG) trace. The video files include a still video image or a video image sequence. The audio files include an audio sound or an audio segment. The visual files include a diagnostic image including, for example, a magnetic resonance image (MRI), an X-ray, a positive emission tomography (PET) scan, or a sonogram.

The security system 105 communicates with the pooled web servers 106 over a wired or wireless communication path 236 in FIG. 2, otherwise called a network, a link, a channel, or a connection. The communication path 236 may use any type of protocol or data format including an Internet Protocol (IP), a Transmission Control Protocol Internet protocol (TCPIP), a Hyper Text Transmission Protocol (HTTP), an RS232 protocol, an Ethernet protocol, a Medical Interface Bus (MIB) compatible protocol, a Local Area Network (LAN) protocol, a Wide Area Network (WAN) protocol, a Campus Area Network (CAN) protocol, a Metropolitan Area Network (MAN) protocol, a Home Area Network (HAN) protocol, an Institute Of Electrical And Electronic Engineers (IEEE) bus compatible protocol, a Digital and Imaging Communications (DICOM) protocol, a Health Level Seven (HL7) protocol, as well as the secure protocols 224 described herein.

The security system 105 provides remote access to servers (e.g., web servers) and other processing devices to setup, for example, IP Address Security and/or RSA Security, as well as any other security settings, for entities, such as customers (e.g., hospitals). The benefit of the remote access is that the security system 105 provides management of configuration information from a central location, and may replicate a configuration for a customer across multiple servers, which eliminates errors made by setting up servers manually.

A security system 105 automates the setup and configuration of any server (or other processing device) that uses IP Address restrictions, RSA security, or other security arrangements, as their security mechanism. The security system 105 configures a virtual (and physical file) directory across an enterprise from a central location. Multiple servers may be configured from a central location in exactly the same manner or differently, for example. The security system 105 performs the following functions, for example, automatically:
1. Scans a list of predefined servers to find which servers have the appropriate virtual directories to apply the IP Address security to.
2. Assigns the same IP Address Restrictions and/or RSA security to the appropriate virtual directories.
3. Manages lists of pooled servers.
4. Manages lists of default IP Address restrictions.
5. Centrally manages custom server IP Address and/or RSA security configurations.

Running the security system 105 from a central location provides the following beneficial features, for example:
1. Central management of customer configuration data.
2. Central management of changes to an entity's production/test environment.
3. Eliminates the need to log on locally to each individual server.
4. Reduces configuration implementation time (e.g., to minutes instead of hours).
5. Provides the ability to bring a new server online with of the customer configurations for a given pool of servers.
6. Provides the ability to import customer configuration from a specific virtual directory.
7. Automatically gathers information.
8. Reduces errors.
9. Applies global changes to customer configurations (e.g., RSA security and/or IP Address changes) from a central location.
10. Provides configuration information validation.
11. Stores configuration information where it is needed.
12. Verifies of server connectivity from a central location.
13. Provides an audit trail to view an entity's activity.

The security system 105 performs the following beneficial functions, for example:
1. Adds/Modifies IP Address restrictions on multiple servers.
2. Adds/Modifies RSA Security restrictions on multiple servers.
3. Manages default settings for server pool listings. This feature also provides the ability to forcibly remove servers so that, even if servers are added to a customer configuration from within the application, the security system 105 automatically removes the servers from the list.
4. Verifies server connectivity before allowing servers to be added to the server pools.
5. Manages default settings for IP Address restrictions. This feature also provides the ability for forcibly remove IP Restrictions so that, even IP restrictions are added to a customer configuration from within the application, security system 105 automatically removes the IP restrictions from the list.
6. Gives the ability to import customer configurations from any virtual directory.
7. Collects and validates the following information to pass to the net access IP security tool 108 and the net access RSA security tool 109:
   a. Provides to applications.
      1) Customer configuration name.
      2) Web site name.
      3) Production and/or test virtual directory.
      4) Server listing.
   b. Provides to the RSA Security tool 109.
      1) RSA security hospital region code (HHRR).
      2) RSA security group name.
      3) Physical path of the virtual directory(s).
   c. Provides to the IP security tool 108.
      1) IP address restriction list.

For each user in the system 100, the security system 105 creates a configuration data file by acquiring the following information, for example:
1. User name.
2. Server names to associate with security settings.
3. Website name the users are installed under for each server.
4. Production virtual directory name.
5. Test virtual directory name.
6. Application service provider (ASP) and user IP address restrictions.
7. Remote secure access (RSA) and/or access control entry (ACE) security hospital region code (HHRR).
8. RSA and/or ACE security HHRR description.

Items 3, 4, and 5 immediately herein above are acquired once, and are assumed to be the same on multiple servers.

After the security system 105 creates the configuration data file, the security system 105 passes the information in the configuration data file to RSA Security tool 109 and/or the IP Security tool 108.

Publishing the security configuration application allows central management of the code and configuration information. The security system 105 allows access to the configuration information at the place that needs the data and interfaces with other security management systems that perform the actual setup of the configuration information. The security management system is usable to manage configuration information across multiple servers and other processing devices. The Security management system may be used for remotely managing server configuration information in an enterprise environment.

The security system 105 addresses and solves the following problems, for example:

1. Problem one: determining and managing customer configuration information. The security system 105 is centrally located and remotely manages multiple customer configurations. The security system 105 eliminates a need to log on locally to each box to determine what security settings are set up for a specific customer. The security system 105 also performs time-consuming verifications of customer configurations by automatically scanning servers.

2. Problem two: new server initialization related to bringing new servers online with the existing customer configurations from another server. The security system 105 has the ability to bring up a new server with the customer configurations from another server. The security system 105 also provides validation to verify that the appropriate customers are built on the server. The security system 105 loops through current customer configurations, validates which server pool they belong to, and applies the appropriate customer configurations to the new server.

3. Problem three: global IP restriction changes. The security system 105 loops through each of the customer configurations, and applies the new restrictions to the configurations using the IP security tool 108, which is also done from a centrally managed location.

4. Problem 4: install errors. Since the security system 105 is centrally located and executes the same configuration against servers in the server list, it ensures that each server is configured the same (or differently, as required). This process eliminates hard to debug random errors that occur when an error is introduced from manual configuration.

5. Problem 5: manually setting up the customer security information is time consuming to install and cumbersome to troubleshoot. The RSA security tool 109 is centrally located and remotely manages any number of servers at the same time to eliminate the need to log on locally to each box. A particular user system may require configuration of eight servers, including six for production and two for test, for example, and the system advantageously reduces the delay and burden involved.

The system advantageously enables customers to be self-sufficient to manage their own application user accounts without requiring another organization's intervention. This results in a real time savings for the customers, and the organization requires fewer personnel to staff the ASP support help desk to perform the account management function.

FIG. 3 illustrates a Security Management System window 300 implemented with the security system 105, as shown in FIG. 2. The window 300 in FIG. 3 includes a menu 301, a Configuration File Name area 302, a Virtual Directory area 303, a Modification area 304, an RSA Security area 305, and a Script area 306. The menu 301 includes, for example, File, Tools, Settings, and Help menus.

The Configuration File Name area 302 further includes a Rename button 309, a Delete button 310, and a File Name box 311. The Rename button 309 permits a user to rename a configuration file displayed in the File Name box 311. The Delete button 310 permits a user to delete one or more configuration files displayed in the File Name box 311. The File Name box 311 displays a configuration file that the user wants to add, modify, or rename.

The Virtual Directory area 303 further includes a Web Site box 312, a Production Virtual Directory box 313, and a Test Virtual Directory box 314. The Web Site box 312 contains a web site address for the hospital, which may be a default address. The Production Virtual Directory box 313 displays the hospital's production virtual directory. The Test Virtual Directory box 314 displays the hospital's test virtual directory.

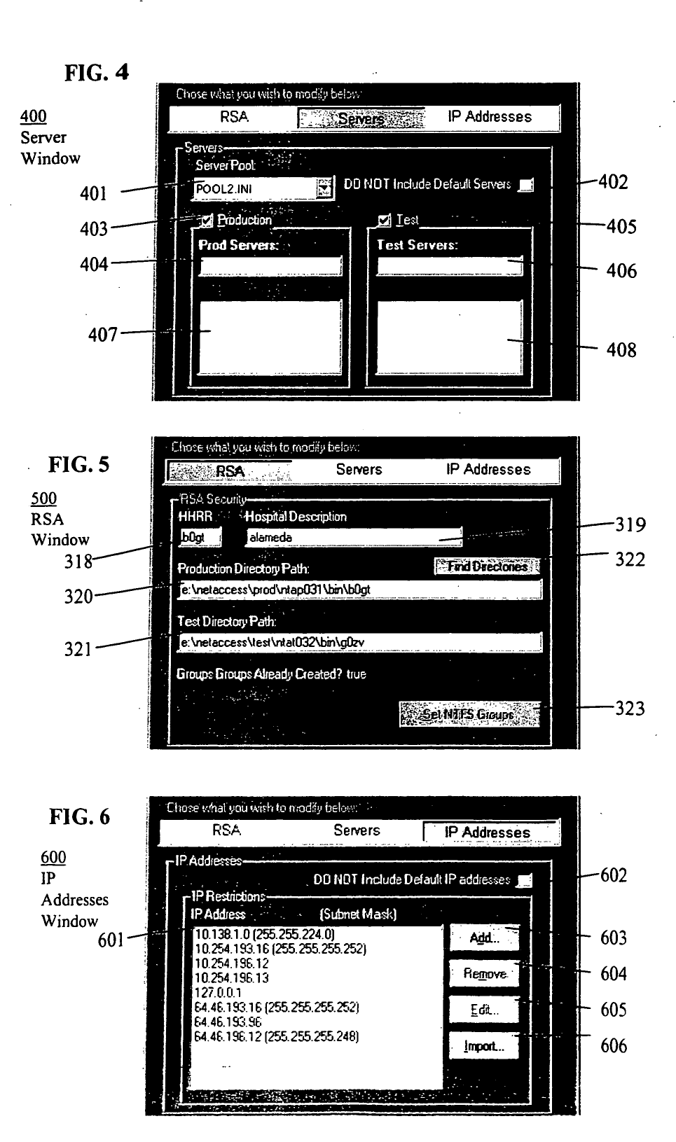

The Modification area 304 further includes an RSA button 315, a Servers button 316, and an IP Addresses button 317. When the user selects the RSA button 315, the security system 105 in FIG. 2 displays the RSA window 500, shown in FIG. 5. When the user selects the Servers button 316, the security system 105 in FIG. 2 displays the Servers window 400, shown in FIG. 4. When the user selects the IP Addresses button 317, the security system 105 in FIG. 2 displays the IP Addresses window 600, shown in FIG. 6.

The RSA security area 305 further includes a hospital region code (HHRR) box 318, a Hospital Description box 319, a Production Directory Path box 320, a Test Directory Path box 321, a Find Directories button 322, a Set (Windows®) NT File System (NTFS) Groups button 323, and a Groups Already Created message 327. The HHRR box 318 displays the code associated with a corresponding hospital. The Hospital Description box 319 displays the name of the hospital. The Production Directory Path box 320 displays the directory path for the production servers 110. The Test Directory Path box 321 displays the directory path for the test servers 111. The Find Directories button 322 automatically finds the directory paths for the production servers 110 in FIG. 1 and the test servers 111 in FIG. 1 to avoid human errors related to manually enter the paths. The NTFS Groups button 323 causes the security system 105 to apply only the displayed RSA information in the RSA security area 305 to the selected configuration file. The Groups Already Created message 327 provides an indication (e.g., True/False, or Yes/No) of whether NTFS local groups need to be applied the next time the security manager application 222 in FIG. 2 runs the present configuration.

The Script area 306 further includes a Scripts box 324, an Apply button 325, and a Run Script button 326. The Scripts box 324 displays the changes the user made to the configuration file. The Apply button 325 causes the security system 105 in FIG. 2 to save the configuration file, without running the configuration file. The Run Script button 326 causes the security system 105 in FIG. 2 to save and apply the configuration file to the selected servers.

FIG. 4 illustrates a Server window 400 implemented with the security system 105, as shown in FIG. 2. The window 400 in FIG. 4 includes a Server Pool box 401, a Default Servers check box 402, a Production Servers check box 403, a Production Servers box 404, a Test Servers check box 405, a Test Servers box 406, a Production Servers List box 407, and a Test Servers List box 408. The Server Pool box 401 displays server pools for the user to select. The Default Servers check box 402 causes the security system 105 in FIG. 2 to not include default servers in the server pools displayed in the Server Pool box 401. The Production Servers check box 403 causes the security system 105 in FIG. 2 to include production servers 110 in FIG. 1 in the server pools displayed in the Server Pool box 401. The Production Servers box 404 permits the user to enter the name of a production server. The Test Servers check box 405 causes the security system 105 in FIG. 2 to include test servers 111 in FIG. 1 in the server pools displayed in the Server Pool box 401. The Test Servers box 406 permits the user to enter the name of a test server. The Production Servers List box 407 displays the names of the productions servers. The Test Servers List box 408 displays the names of the test servers.

FIG. 5 illustrates a remote secure access (RSA) window 500 implemented with the security system 105, as shown in FIG. 2. The window 500 in FIG. 5 includes the same buttons and boxes (reference items 318-323) that are shown and described in the RSA area 305 in FIG. 3.

FIG. 6 illustrates an Internet Protocol (IP) Addresses window 600 implemented with the security system 105, as shown in FIG. 2. The window 600 in FIG. 6 includes an IP Addresses box 601, a Default IP Addresses check box 602, an Add button 603, a Remove button 604, an Edit button 605, and an Import button 606. The IP Addresses box 601 displays restricted IP addresses. The Default IP Addresses check box 602 permits a user to not include default IP address restrictions. When the user checks the default IP Addresses check box 602, the security system 105 causes global IP address restrictions that the user made using Settings in the menu 301 in FIG. 3 to not be applied to the selected configuration file. The Add button 603 causes the security system 105 in FIG. 2 to add IP addresses. The Remove button 604 causes the security system 105 in FIG. 2 to remove IP addresses. The Edit button 605 causes the security system 105 in FIG. 2 to modify IP addresses. The Import button 606 causes the security system 105 in FIG. 2 to import IP addresses.

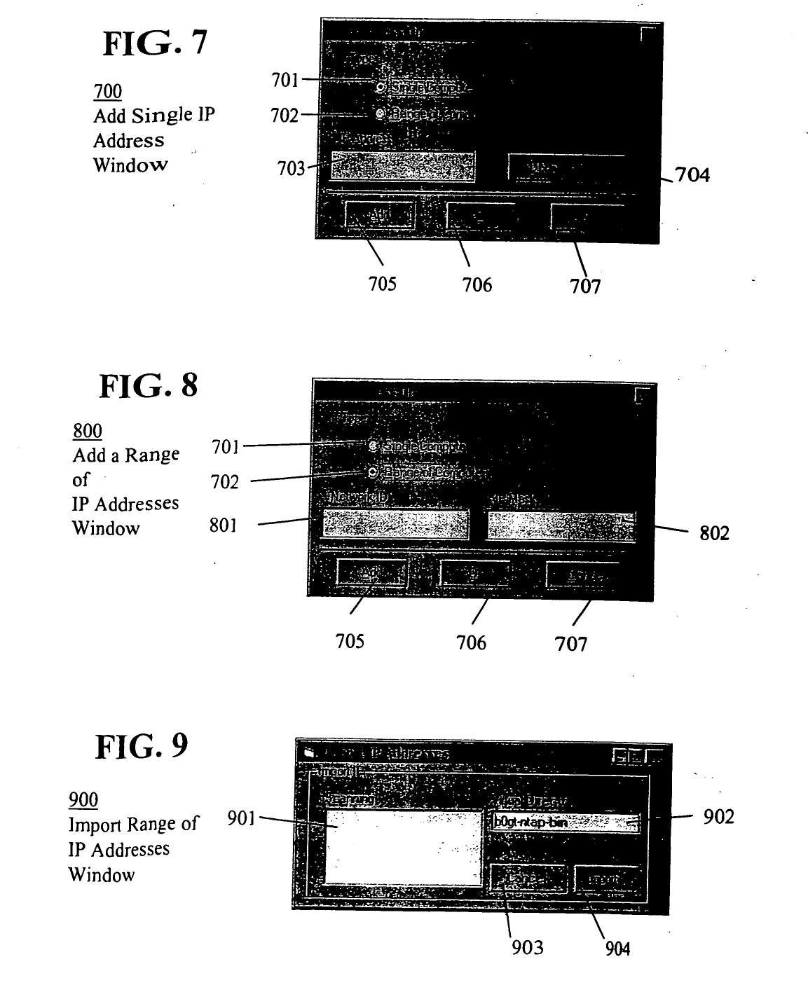

FIG. 7 illustrates an Add Single IP Address window 700 implemented with the security system 105, as shown in FIG. 2. The window 700 in FIG. 7 includes a Single Computer check box 701, a Range Of Computers check box 702, an IP Address box 703, a Domain Name Server (DNS) lookup button 704, an Add button 705, an OK button 706, and a Cancel button 707. The Single Computer check box 701 prompts the security system 105 in FIG. 2 to receive an IP address for a single computer. The Range Of Computers check box 702 prompts the security system 105 in FIG. 2 to receive a range of IP addresses for multiple single computers. The IP Address box 703 permits a user to enter an IP address for a single computer. User selection of the Domain Name Server (DNS) lookup button 704 causes the security system 105 in FIG. 2 to look up an IP address. User selection of the Add button 705 causes the security system 105 in FIG. 2 to add the IP address to the list of restricted IP addresses in the IP Addresses box 601. User selection of the OK button 706 causes the security system 105 in FIG. 2 to automatically enter a selected IP address looked up using the DNS Lookup button 704. User selection of the Cancel button 707 causes the security system 105 in FIG. 2 to reset or, alternatively, close the window 700 in FIG. 7.

FIG. 8 illustrates an Add a Range of IP Addresses window 800 implemented with the security system 105, as shown in FIG. 2. The window 800 in FIG. 8 includes the same boxes and buttons referenced in FIG. 7 as 701, 702, 705, 706, and 707, and a Network Identification (ID) 801, and an IP Mask 802. The Network Identification (ID) 801 and the IP Mask 802 permit the user to enter a range of IP addresses into the security system 105 in FIG. 2.

FIG. 9 illustrates an Import a Range of IP Addresses window 900 implemented with the security system 105, as shown in FIG. 2. The window 900 in FIG. 9 includes a Scanning window 901, a Virtual Directory box 902, a Cancel button 903, and an Import IP button 904. The Scanning window 901 displays the IP addresses associated with the virtual directory displayed in the Virtual Directory box 902. The Virtual Directory box 902 displays the name of the directory into which the IP addresses will be imported. The Cancel button 903 causes the security system 105 in FIG. 2 to reset or, alternatively, close the window 900 in FIG. 9. The Import IP button 904 causes the security system 105 in FIG. 2 to import the IP addresses into the directory named in the Virtual Directory box 902.

FIG. 10 illustrates a Default Servers window 1000 implemented with the security system 105, as shown in FIG. 2. The window 1000 in FIG. 1000 includes a Server Pool box 1001, a Production Servers area 1002, a Test Servers area 1003, an OK button 1004, a Cancel button 1005, and a File menu 1014. The Production Servers area 1002 further includes a Production Servers box 1006, a Production Servers Enable button 1007, a Productions Servers Delete button 1008, and a Productions Servers List box 1009. The Test Servers area 1003 further includes a Test Servers box 1010, a Test Servers Enable button 1011, a Test Servers Delete button 1012, and a Test Servers List box 1013.

The Server Pool box 1001 permits a user to select a server pool. User selection of the OK button 1004 causes the security system 105 in FIG. 2 to add names of production servers and/or test servers entered into the Productions Servers box 1006 and the Test Servers box 1010, respectively. User selection of the Cancel button 1005 causes the security system 105 in FIG. 2 to reset or, alternatively, close the window 1000 in FIG. 10. User selection of New under the File menu 1014 causes the security system 105 in FIG. 2 to create a new server pool. The Production Servers box 1006 permits the user to enter the names of production servers to be added to the server pool. The Production Servers Enable button 1007 causes the security system 105 in FIG. 2 to enable the name of one or more production servers from the server pool. The Productions Servers Delete button 1008 causes the security system 105 in FIG. 2 to delete the name of one or more production servers from the server pool. The Productions Servers List box 1009 displays a list of the names of the production servers associated with the server pool. The Test Servers box 1010 permits the user to enter the names of test servers to be added to the server pool. The Test Servers Enable button 1011 causes the security system 105 in FIG. 2 to enable the name of one or more test servers from the server pool. The Test Servers Delete button 1012 causes the security system 105 in FIG. 2 to delete the name of one or more test servers from the server pool. The Test Servers List box 1013 displays a list of the names of the test servers associated with the server pool.

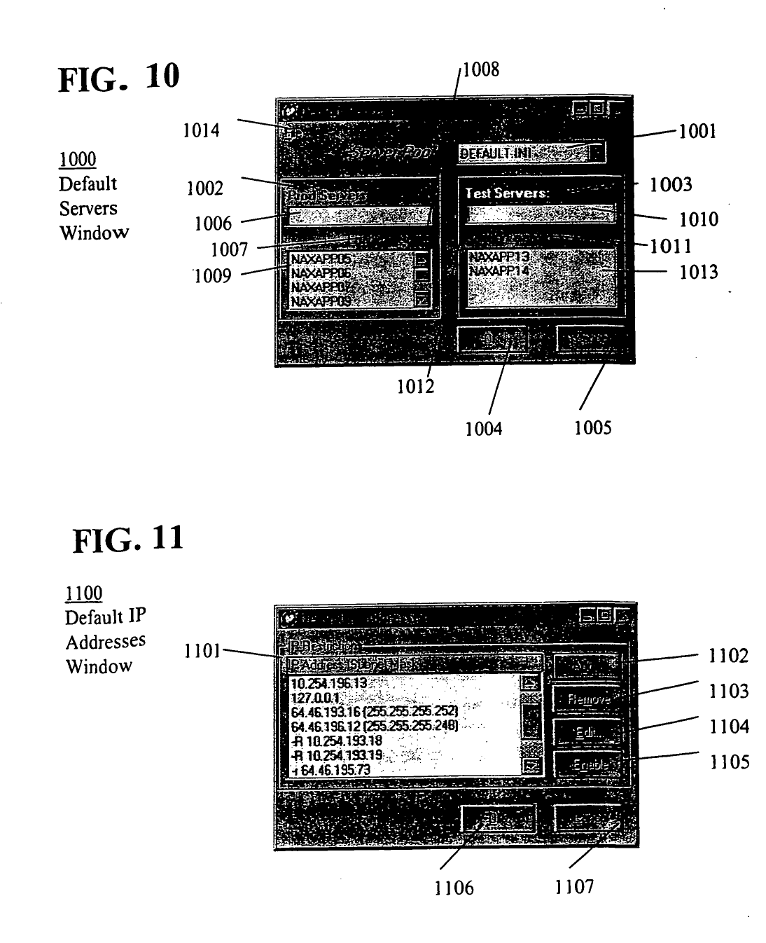

FIG. 11 illustrates a Default IP Addresses window 1100 implemented with the security system 105, as shown in FIG. 2. The window 1100 in FIG. 11 includes an IP Address box 1101, an Add button 1102, a Remove button 1103, an Edit button 1104, an Enable button 1105, an OK button 1106, and a Cancel button 1107. The IP Address box 1101 permits the user to select one or more IP addresses. User selection of the Add button 1102 causes the security manager to add the one or more selected IP addresses to one or more selected configuration files displayed in the File Name box 311 in FIG. 3. User selection of the Remove button 1103 causes the security manager to delete or disable one or more selected IP addresses from one or more selected configuration files displayed in the File Name box 311 in FIG. 3. User selection of the Edit button 1104 causes the security manager to edit a selected IP address associated with one or more selected configuration files displayed in the File Name box 311 in FIG. 3. User selection of the Enable button 1105 causes the security manager to enable (i.e., reactivate) a selected IP address associated with one or more selected configuration files displayed in the File Name box 311 in FIG. 3. User selection of the OK button 1106 causes the security system 105 in FIG. 2 to add, remove, edit, or enable the IP addresses selected in the IP Address box 1101. User selection of the Cancel button 1107 causes the security system 105 in FIG. 2 to reset or, alternatively, close the window 1100 in FIG. 11.

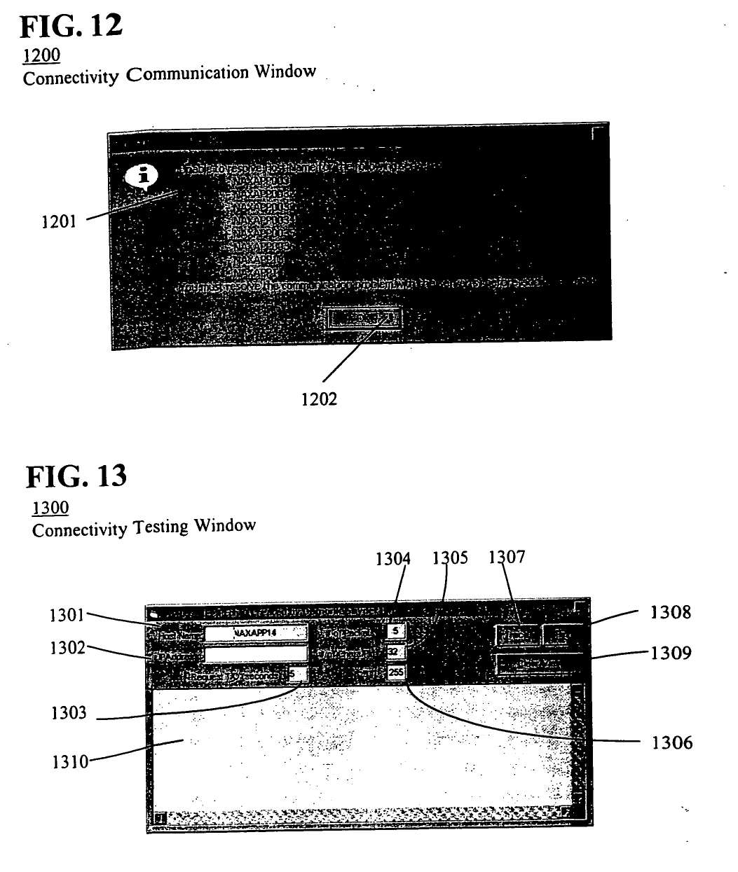

FIG. 12 illustrates a Connectivity Communication window 1200 implemented with the security system 105, as shown in FIG. 2. The window 1200 in FIG. 12 includes a Message 1201 and an OK button 1202. The Message 1201 is a statement from the security system 105 in FIG. 2 notifying the user about which servers have a communication problem. User selection of the OK button 1202 causes the security system 105 in FIG. 2 to close the window 1200 in FIG. 12.

FIG. 13 illustrates a Connectivity Testing window 1300 implemented with the security system 105, as shown in FIG. 2. The window 1300 in FIG. 1300 includes a Host Name box 1301, an IP Address box 1302, a Request Time/Out (T/O) box 1303, a Number Of Packets box 1304, a Number Of Characters Per Packet box 1305, a Time To Live (TTL) box 1306, a Trace button 1307, a Ping button 1308, a Clear View button 1309, and a Display box 1310. The Host Name box 1301 permits the user to enter the host name for the server whose connectivity is being tested. As an alternative to entering the host name, the IP Address box 1302 permits the user to enter the IP address for the named server. The Request T/O box 1303 permits the user to enter the time out in units of seconds. The Number Of Packets box 1304 permits the user to enter the number of packets transmitted to the named server being tested. The Number Of Characters Per Packet box 1305 permits the user to enter the number of characters per packet transmitted to the named server being tested. The TTL box 1306 permits the user to enter the time to live for the test signal transmitted to the named server. User selection of the Trace button 1307 causes the security system 105 to trace the route of the test signal transmitted to the named server. User selection of the Ping button 1308 causes the security system 105 to ping (i.e., send a test signal and wait for a return signal) the named server. User selection of the Clear View button 1309 resets or clears the contents of the boxes 1301 to 1306. The Display box 1310 displays the results of the connectivity testing responsive to the test signal being transmitted to the named server according to the user entered parameter in boxes 1303 to 1306.

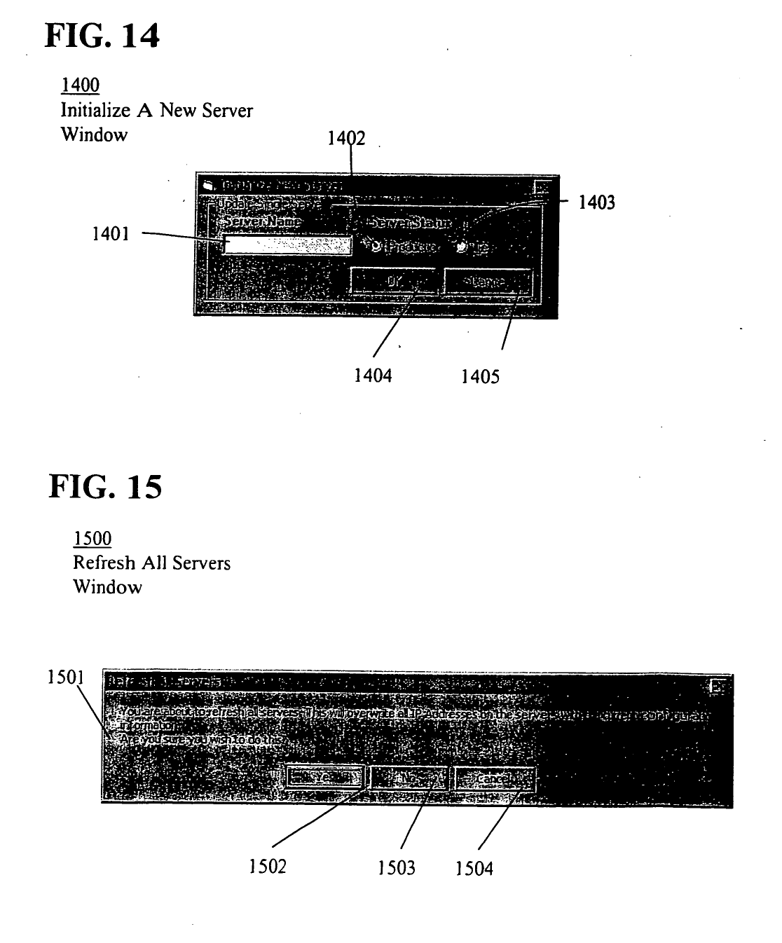

FIG. 14 illustrates an Initialize A New Server window 1400 implemented with the security system 105, as shown in FIG. 2. The window 1400 in FIG. 14 includes a Server Name box 1401, a Production Server check box 1402, a Test Server check box 1403, an OK button 1404, and a Cancel button 1405. The Server Name box 1401 permits the user to enter the name of the server being initialized. The Production Server check box 1402 permits the user to identify the named server as a production server 110 in FIG. 1. The Test Server check box 1403 permits the user to identify the named server as a test server 111 in FIG. 1. User selection of the OK button 1404 causes the security system 105 in FIG. 2 to associate the named configuration file in the File Name box 311 in FIG. 3 to the named production or test server. User selection of the Cancel button 1405 causes the security system 105 in FIG. 2 to reset or, alternatively, close the window 1400 in FIG. 14.

FIG. 15 illustrates a Refresh All Servers window 1500 implemented with the security system 105, as shown in FIG. 2. The window 1500 in FIG. 15 includes a Message 1501, a Yes button 1502, a No button 1503, and a Cancel button 1504. The Message 1501 warns the users that refreshing the servers will overwrite the IP addresses on the servers with the current configuration information, and asks the user to confirm, deny, or cancel the refresh function. User selection of the Yes button 1502 causes the security system 105 in FIG. 2 to refresh (i.e., overwrite IP addresses on the servers with current configuration file information) the servers. User selection of the No button 1503 causes the security system 105 in FIG. 2 not to refresh the servers. User selection of the Cancel button 1504 causes the security system 105 in FIG. 2 to close the window 1500 in FIG. 15.

The following text describes methods, including methods 1600 to 2700 illustrated in FIGS. 16 to 27, respectively, employed by the security system 105, as shown in FIG. 2. Some of the methods employ various windows 300 to 1500, illustrated in FIGS. 3 to 15, respectively, which a person uses to interact with the security system 105.

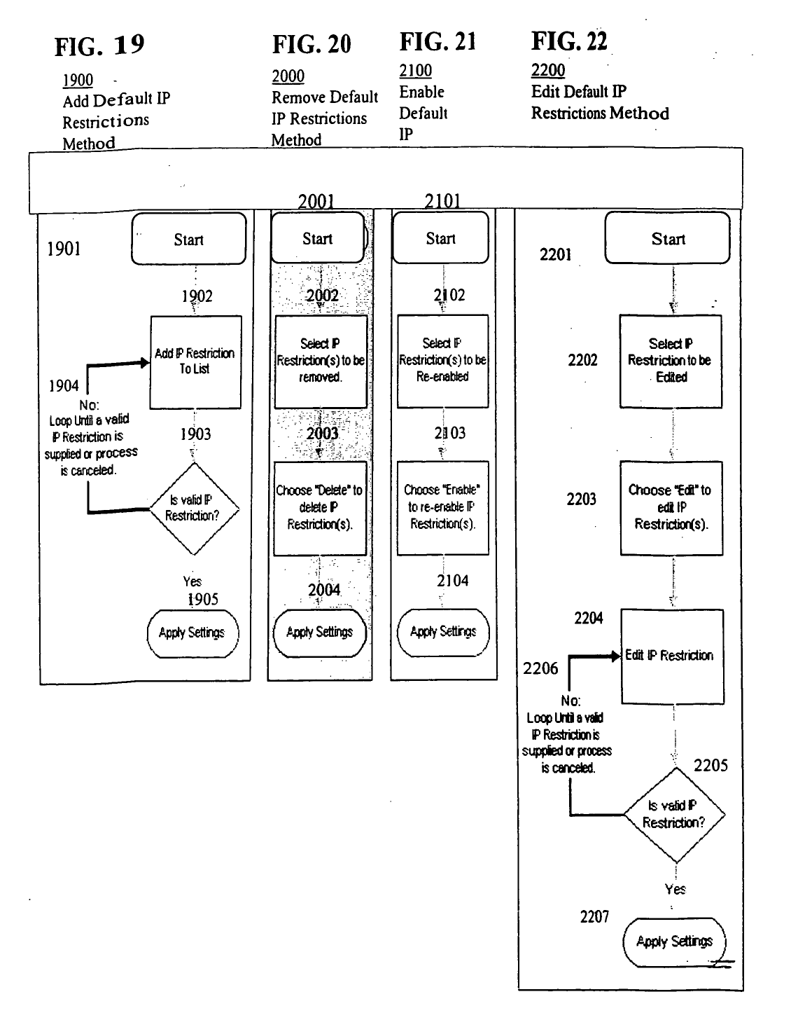

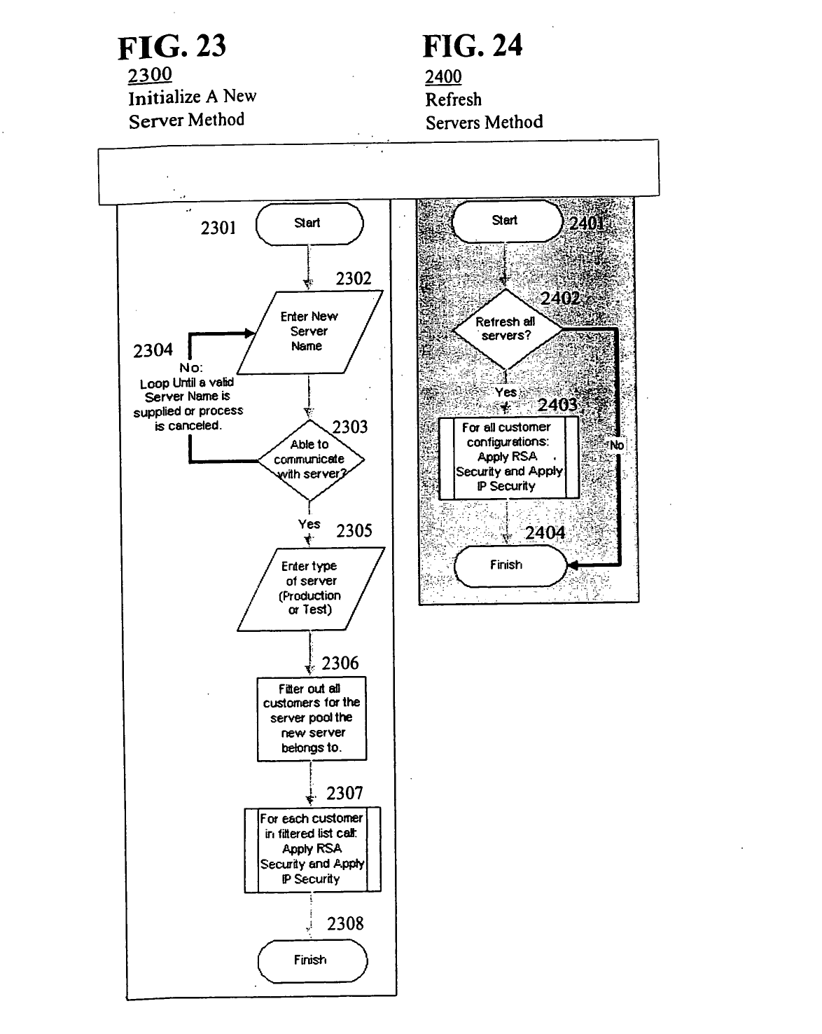

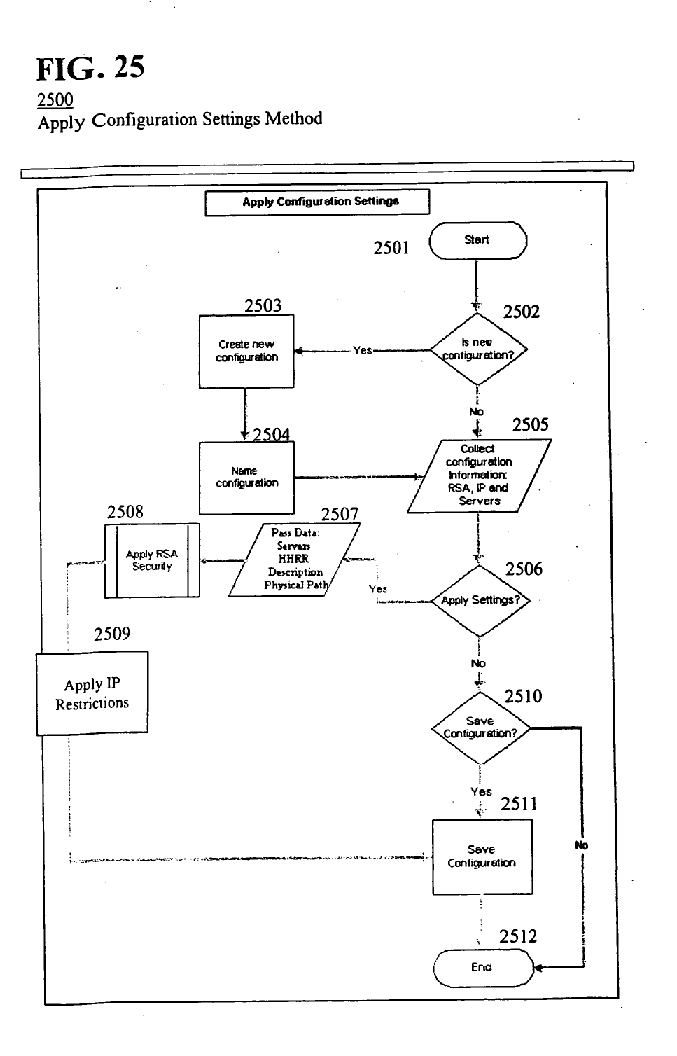

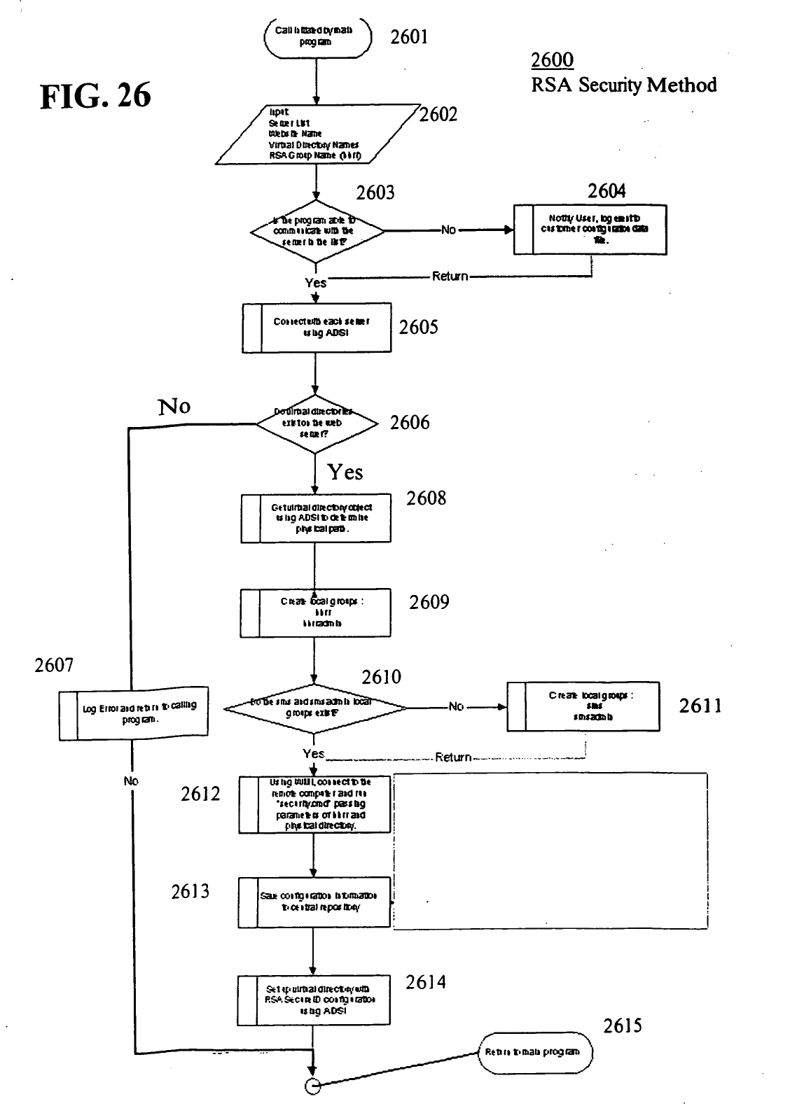

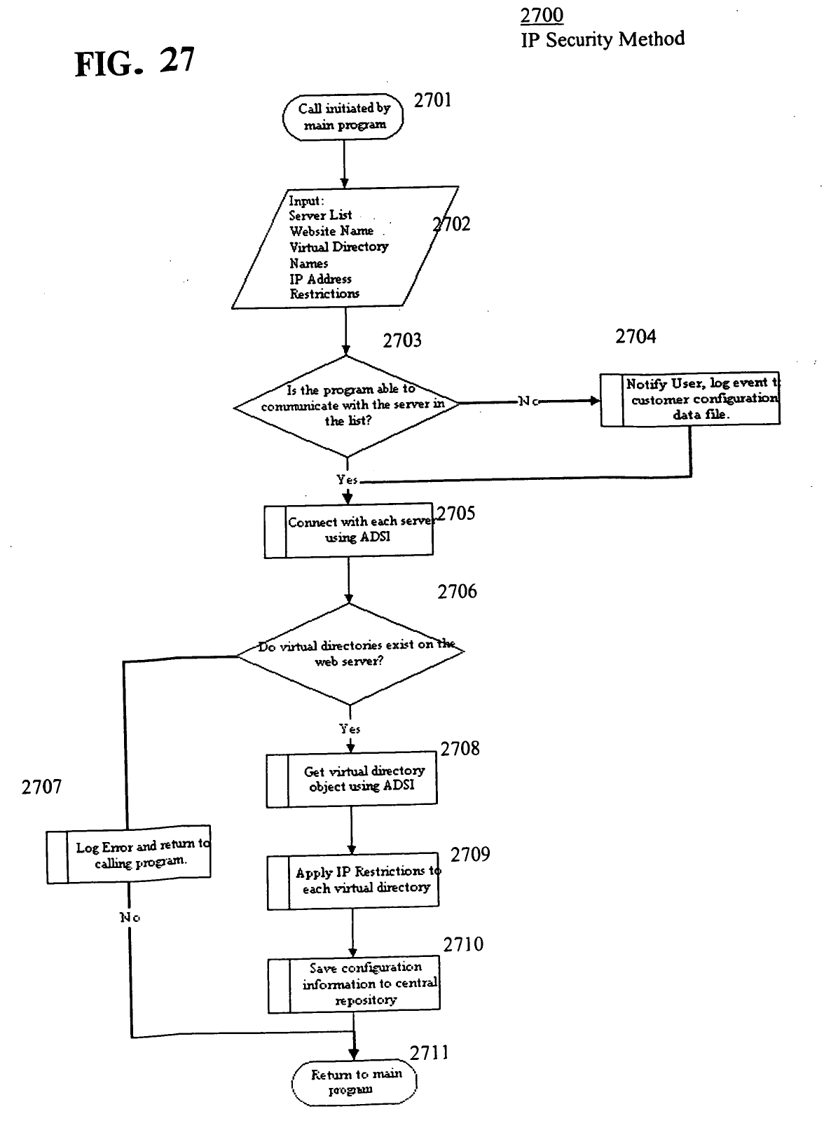

The security manager 107 and each of the RSA security tool 109 and the IP security tool 108 depend on each other to complete the process. The security manager 107 collects and validates the information required and passes that information to the RSA security tool 109 and/or the IP security tool 108. The following is a users guide to show the functional operation and interaction of the security manager 107 with each of the RSA security tool 109 and the IP security tool 108. The methods include the following:
A. Accessing the security system 105 illustrated in FIG. 2.
B. Setting up configuration files.
   1. Creating a new configuration file, as described in method 2500 illustrated in FIG. 25.
   2. Copying or migrating a configuration file.
   3. Deleting a configuration file.
   4. Renaming a configuration file.
C. Setting up, modifying, and deleting server pools server pools, as described in methods 1600 to 1800 illustrated in FIGS. 16 to 18.
D. Setting up default (e.g., global) IP address restrictions, as described in method 1900 to 2200 illustrated in FIGS. 19 to 22.
E. Validating connectivity to a server.
F. Performing connectivity testing for a server.
G. Initializing a new server, as described in method 2300 illustrated in FIG. 23.
H. Refreshing configuration files after a global change, as described in method 2400 illustrated in FIG. 24.
I. Applying RSA security to a server, as described in method 2600 illustrated in FIG. 26.
J. Applying IP restrictions to a server, as described in method 2700 illustrated in FIG. 27.

A. Accessing the Security System 105

A user starts an IP Security function from an Application Specific Provider (ASP) Support Desktop to access the security system 105, illustrated in FIG. 2. Starting the IP Security function causes the Security Management System window 300, shown in FIG. 3, to be displayed. The user interfaces with the window 300 to perform the methods listed as B to J, hereinabove.

B. Setting Up Configuration Files

Setting up configuration files includes creating a new configuration file, copying or migrating a configuration files, deleting a configuration file, and renaming a configuration file.

1. Creating a New Configuration File

The user interfaces with the security system 105, shown in FIG. 2, via the window 300, shown in FIG. 3, to create a new configuration file and associate it with a pool of servers. The user selects New under File from the menu 301 in FIG. 3 to cause the security system 105 to create a new configuration file. Under the configuration file name area 302 in FIG. 3, the user types or selects the name of the new file in the file name box 311 in FIG. 3 using the format “Hospital Name” (HHRR) (e.g., ALAMEDA (B0GT)). In the virtual directory area 303 in FIG. 3, the user enters appropriate information into each of the web site box 312 (e.g., a default web site address), the production virtual directory box 313 (e.g., adding the hospital's HHRR to the default displayed value (e.g., b0gt-ntap-bin)), and the test virtual directory box 314 (e.g., adding the hospital's HHRR to the defaulted displayed value (e.g. g0zn-ntat-bin)).

The user selects the Servers button 316 to cause the security system 105 to display the server window, shown in FIG. 4, to permit the user to set up a server pool. In the server window 400 in FIG. 4, the user selects the server pool that the user wants to associate with the particular configuration file displayed in the file name box 311 in FIG. 3. In the server pool box 401, the user uses the drop-down arrow to select the server pool that the hospital is configured on. The user can override the server pool listing to add a custom server list by checking the default servers check box 402 to not include default servers.

The user selects the RSA button 315 to cause the security system 105 to display the RSA window 500, shown in FIG. 5, to permit the user to set up RSA information. The HHRR box 318 displays by default the HHRR previously entered by the user in the window 300 in FIG. 3 (e.g., in the production virtual directory box 313). The hospital description box 319 displays by default the hospital name previously entered by the user in the window 300 in FIG. 3 (e.g., in the file name box 311). Alternatively, the user may enter the hospital name and the HHRR directly into the HHRR box 318 and the hospital description box 319, respectively. The user should ensure that the hospital name and the HHRR are the same hospital name and the HHRR that are used to set up the access control entry (ACE) accounts in the ACE database to permit reliable and consistent remote access. The hospital name and the HHRR are used to create the local groups on each server listed in the pool of servers, as shown in Table 1.

TABLE 1

| Group Name | Description |
|---|---|
| HHRR | Hospital Description |
| HHRRadmin | Hospital Description Administrator |
| SMS | Application Service Provider (ASP) |
| SMSadmin | ASP Administrator |

The user selects the Find Directories button 322 to cause the security system 105 to automatically find the physical location (i.e., paths) on each of the pooled web servers 106 for the production servers 110 and the test servers 111 that the NTFS Local Groups need to be applied to. If the user or the security system 105 modifies any of the fields in the RSA window 500 for the named hospital, the security manager application 222 in FIG. 2 causes the Groups Already Created message 327 message to be False (or No). The next time the security manager application 222 in FIG. 2 runs the present configuration, the security manager application 222 in FIG. 2 is re-run to apply the new security settings.

The user selects the IP Addresses button 317 to cause the security system 105 to display the IP Addresses window 600, shown in FIG. 6, to permit the user to set up IP Address information.

The user initiates a process of adding a single IP address restriction by selecting the Add button 603 to cause the security system 105 to display the Add a Single IP Address window 700, shown in FIG. 7. In the window 700 in FIG. 7, the user selects the Single Computer check box 701 to cause the security system 105 to select an IP address for a single computer. The user enters the IP address in IP Address box 703 in FIG. 7. The user may select the DNS Lookup button 704 in FIG. 7 to cause the security system 105 to look up the IP address, if necessary, which may then be manually or automatically (e.g., by the user selecting the OK button 706) entered into the IP Address box 703. The user selects the Add button 705 in FIG. 7 to cause the security system 105 to add the IP address, which is displayed in the IP Address box 703, to the list of IP addresses displayed in the IP Addresses box 601 in FIG. 6.

The user initiates a process of adding a range of IP address restrictions by selecting the Add button 603 to cause the security system 105 to display the Add a Range of IP Addresses window 800, shown in FIG. 8. In the window 800 in FIG. 8, the user selects Single Computer check box 701 to enable selection of an IP address for a single computer, and the user selects the Range Of Computers check box 702 to enable selection of an IP address for a range of computers. The user enters the range of IP addresses in the Network ID 801 and an IP Mask 802 in FIG. 8. Alternatively (but not shown in FIG. 8), the user may select (e.g., using a DNS Lookup button) to cause the security system 105 to look up the range of IP addresses, which may then be manually or automatically (e.g., by the user selecting the OK button 706) entered into the Network ID 801 and an IP Mask 802 in FIG. 8. The user selects the Add button 705 in FIG. 7 to cause the security system 105 to add the range of IP addresses, which is displayed in the Network ID 801 and an IP Mask 802 in FIG. 8, to the list of IP addresses displayed in the IP Addresses box 601 in FIG. 6.

Returning to FIG. 6, the user selects one or more IP addresses displayed in the IP Addresses box 601 in FIG. 6, and then selects the Remove button 604 in FIG. 6 to cause the security system 105 to remove the one or more IP addresses.

Continuing with FIG. 6, the user selects one or more IP addresses displayed in the IP Addresses box 601 in FIG. 6, and then selects the Edit button 605 in FIG. 6 to cause the security system 105 to permit the user to edit the one or more IP addresses.

Continuing with FIG. 6, the user initiates a process of importing one or more IP addresses by selecting the Import button 606 to cause the security system 105 to display the Import the Range of IP Addresses window 900, shown in FIG. 9. Upon opening the window 900 in FIG. 9, the security system 105 in FIG. 2 scans the stand-alone servers, as well as the first server from each default server pool configured, and displays the list of imported IP addresses in the scanning widow 901. However, if the user is not an intranet user, the security system 105 in FIG. 2 scans IP addresses internal to the hospital.

The user selects the Import IP button 904 associated with the path displayed in the Virtual Directory window 902. The user selects the Import IP button 904 to cause the security system 105 to add the list of imported IP addresses, which are displayed in the scanning widow 901, to the list of IP addresses displayed in the IP Addresses box 601 in FIG. 6.

Returning to FIG. 3, after the user finishes creating the new configuration file, the user selects the Apply button 325 in FIG. 3 to save the configuration file, without running the configuration file. The scripts box 324 displays the changes the user made to the configuration file. The user selects the Run Script button 326 in FIG. 3 to save and apply the configuration file to the selected servers.

FIG. 25 illustrates an Apply Configurations method 2500 implemented with the security system 105, as shown in FIG. 2.

At step 2501, the method 2500 starts.

At step 2502, the security system 105 in FIG. 2 determines whether the file configuration to be applied is new or old. If the determination at step 2502 is positive, then the method 2500 continues to step 2503; otherwise, if the determination at step 2502 is negative, then the method 2500 continues to step 2505.

At step 2503, the security system 105 in FIG. 2 receives a new configuration to be created.

At step 2504, the security system 105 in FIG. 2 receives a file name configuration.

At step 2505, the security system 105 in FIG. 2 collects configuration information from the server window 400 in FIG. 4, the RSA window 500 in FIG. 5, and the IP Addresses window 600 in FIG. 6.

At step 2506, the security system 105 in FIG. 2 determines whether the configuration settings shall be applied. If the determination at step 2506 is positive, then the method 2500 continues to step 2507; otherwise, if the determination at step 2506 is negative, then the method 2500 continues to step 2510.

At step 2507, the security system 105 in FIG. 2 sends configuration data (e.g., server names, HHRR data, physical path description, etc.) to the RSA security tool 109 and/or the IP security tool 108.

At step 2508, the security system 105 in FIG. 2 applies RSA security.

At step 2509, the security system 105 in FIG. 2 applies IP security (e.g., IP restrictions). After step 2509, the method 2500 continues to step 2511.

At step 2510, the security system 105 in FIG. 2 determines whether the configuration settings shall be saved. If the determination at step 2510 is positive, then the method 2500 continues to step 2511; otherwise, if the determination at step 2510 is negative, then the method 2500 continues to step 2512.

At step 2511, the security system 105 in FIG. 2 saves the configuration.

At step 2512, the method 2500 ends.

2. Copying or Migrating a Configuration File

Under the configuration file name area 302 in FIG. 3, the user types or selects the name of the file in the file name box 311 in FIG. 3 that the user wants to copy. The user selects Copy under File from the menu 301 in FIG. 3 to cause the security system 105 to copy the selected configuration file.

The user selects the Servers button 316 to cause the security system 105 to display the server window 400, shown in FIG. 4, to permit the user to modify the server pool associated with the selected configuration file. The user interfaces with the server window 400 in FIG. 4, as already described herein.

The user selects the RSA button 315 to cause the security system 105 to display the RSA window 500, shown in FIG. 5, to permit the user to modify the RSA information. The user interfaces with the server window 500 in FIG. 5, as already described herein. In addition, the user selects the Set NTFS Groups button 323 in FIG. 5, instead of the Run Scripts button 326 in FIG. 3 to cause the security system 105 to modify RSA information only for the selected configuration file. The Set NTFS Groups button 323 applies the information that the user changes in the RSA window 500, without needlessly causing the security system 105 to reapply the information already set up in the Server window 400 in FIG. 4 and in the IP Addresses window in FIG. 6.

The user selects the IP Addresses button 317 to cause the security system 105 to display the IP Addresses window 600, shown in FIG. 6, to permit the user to modify IP Address information. The user interfaces with the server window 600 in FIG. 6, as already described herein.

Returning to FIG. 3, after the user finishes modifying the selected configuration file, the user selects the Apply button 325 in FIG. 3 to save the modified configuration file, without running the configuration file. The scripts box 324 displays the changes the user made to the modified configuration file. The user selects the Run Script button 326 in FIG. 3 to save and apply the modified configuration file to the servers that the user selected.

3. Deleting a Configuration File

Under the configuration file name area 302 in FIG. 3, the user types or selects the name of the file in the file name box 311 in FIG. 3 that the user wants to delete. The user selects Delete under File from the menu 301 in FIG. 3 or the Delete button 310 to cause the security system 105 to delete the select the configuration file.

4. Renaming a Configuration File

Under the configuration file name area 302 in FIG. 3, the user types or selects the name of the file in the file name box 311 in FIG. 3 that the user wants to rename. The user selects Rename under File from the menu 301 in FIG. 3 or the Rename button 309 to permit the user to rename the select the configuration file. The user types the whole or partial new name of the selected configuration file.

C. Setting Up, Modifying, and Deleting Server Pools

The user interfaces with the security system 105 in FIG. 2 to set up, modify, and delete pools of servers. The security system 105 in FIG. 2 automatically numbers the pool for the user. The user can cause the security system 105 in FIG. 2 to add any number of servers to each of the pools. When the user interfaces with the security system 105 in FIG. 2 to define a configuration file, the server pools that the user sets up appear in lists 1009 and 1013, shown in FIG. 10, so that the user can associate the server pool with the selected configuration file.

1. Setting Up Server Pools

Under the configuration file name area 302 in FIG. 3, the user types or selects the name of the file in the file name box 311 in FIG. 3 that the user wants to assign a server pool to. The user selects Default Settings/Default Servers under Settings from the menu 301 in FIG. 3 to cause the security system 105 to display the default servers window 1000, shown in FIG. 10, to permit the user to set up a server pool associated with the selected configuration file.

In the Default Servers window 1000 in FIG. 10, the user selects New under the File menu 1014 to cause the security system 105 in FIG. 2 to create a new server pool. The security system 105 in FIG. 2 automatically numbers the pool for the user. The user enters the name of the production and test servers in the pool in Production Servers box 1006 and the Test Servers box 1010, respectively, in FIG. 10. The user selects the OK button 1004 in FIG. 10 to add the names of the production and test servers to the server pool.

2. Modifying Server Pools

Under the Configuration File Name area 302 in FIG. 3, the user types or selects the name of the file in the File Name box 311 in FIG. 3 for which the user wants to modify a server pool. The user selects Default Settings/Default Servers under Settings from the menu 301 in FIG. 3 to cause the security system 105 to display the Default Servers window 1000, shown in FIG. 10, to permit the user to modify a server pool associated with the selected configuration file.

In the Default Servers window 1000 in FIG. 10, the user selects the server pool in the Server Pool box 1001 that the user wants security system 105 in FIG. 2 to modify (i.e., adding or deleting). The production and test servers in the selected server pool are listed in the Productions Servers List box 1009 and the Test Servers List box 1013, respectively, in FIG. 10.

The user causes the security system 105 in FIG. 2 to delete the selected servers listed in the Productions Servers List box 1009 by selecting the Productions Servers Delete button 1008. The user causes the security system 105 in FIG. 2 to delete the selected servers listed in the Test Servers List box 1013 by selecting the Test Servers Delete button 1012.

The user causes the security system 105 in FIG. 2 to add production and test servers to the selected server pool by entering names of production servers in the Production Servers box 1006 and names of the test servers in the Test Servers box 1010, respectively. Note that the server is not available when defining a configuration file, even if the user tries to enter it manually.

The user selects the OK button 1004 in FIG. 10 to add the names of the production and test servers to the server pool.

FIG. 16 illustrates an Add A Default Server method 1600 implemented with the security system 105, as shown in FIG. 2.

At step 1601, the method 1600 starts.

At step 1602, the security system 105 in FIG. 2 determines whether the desired server already exists in a server pool. If the determination at step 1602 is positive, then the method 1600 continues to step 1604; otherwise, if the determination at step 1602 is negative, then the method 1600 continues to step 1603.

At step 1603, the security system 105 in FIG. 2 receives a new server name, which the user enters.

At step 1604, the security system 105 in FIG. 2 receives the name of a server selected by the user from a list of server names displayed in the Production Server box 1009 or in the Test Server box 1013.

At step 1605, the security system 105 in FIG. 2 adds the selected or named server to the list of servers displayed in the Production Server box 1009 or in the Test Server box 1013.

At step 1606, the security system 105 in FIG. 2 determines whether the security system 105 is able to communicate with the newly added server. If the determination at step 1606 is positive, then the method 1600 continues to step 1608; otherwise, if the determination at step 1606 is negative, then the method 1600 continues to step 1607.

At step 1607, the security system 105 in FIG. 2 returns to step 1605 until the security system 105 receives a valid server name or until the method 1600 is automatically or manually (e.g., by the user) cancelled.

At step 1608, the security system 105 in FIG. 2 receives an indication of user selection of the OK button 1004 in FIG. 10 to cause the security system 105 to add the named server to the server pool.

FIG. 17 illustrates a Remove A Default Server method 1700 implemented with the security system 105, as shown in FIG. 2.

At step 1701, the method 1700 starts.

At step 1702, the security system 105 in FIG. 2 receives the name of a server pool selected by the user from a list of server pools displayed in the server pool box 1101 in FIG. 11.

At step 1703, the security system 105 in FIG. 2 receives the name of a server to be removed, which is selected by the user from a list of server names displayed in the Production Server box 1009 in FIG. 10 or in the Test Server box 1013 in FIG. 10.

At step 1704, the security system 105 in FIG. 2 deletes the name of a server selected by the user from the list of server names displayed in the Production Server box 1009 in FIG. 10 and in the Test Server box 1013 in FIG. 10 responsive to the user selecting the Production Servers Delete button 1008 in FIG. 10 and the Test Servers Delete button 1012 in FIG. 10, respectively.

At step 1705, the security system 105 in FIG. 2 receives an indication of user selection of the OK button 1004 in FIG. 10 to cause the security system 105 to remove the selected server to the server pool.

FIG. 18 illustrates an Enable A Default Server method 1800 implemented with the security system 105, as shown in FIG. 2.

At step 1801, the method 1800 starts.

At step 1802, the security system 105 in FIG. 2 receives the name of a server pool selected by the user from a list of server pools displayed in the server pool box 1101 in FIG. 11.

At step 1803, the security system 105 in FIG. 2 receives the name of a server to be enabled, which is selected by the user from a list of server names displayed in the Production Server box 1009 in FIG. 10 or in the Test Server box 1013 in FIG. 10.

At step 1804, the security system 105 in FIG. 2 enables the name of a server selected by the user from the list of server names displayed in the Production Server box 1009 in FIG. 10 and in the Test Server box 1013 in FIG. 10 responsive to the user selecting the Production Servers Enable button 1007 in FIG. 10 and the Test Servers Enable button 1011 in FIG. 10, respectively.

At step 1805, the security system 105 in FIG. 2 receives an indication of user selection of the OK button 1004 in FIG. 10 to cause the security system 105 to enable the selected server.

D. Setting Up Default (e.g., Global) IP Address Restrictions

The user uses the security system 105 in FIG. 2 in cooperation with the Default IP Addresses window 1100 in FIG. 11 to set up internal global IP addresses restrictions. When the user uses the security system 105 in FIG. 2 to define a configuration file, the IP address restrictions the user sets up here appear when associating IP address restrictions with a particular configuration file. The user is permitted to add (FIG. 19), remove (FIG. 20), enable (FIG. 21), and edit (FIG. 22) IP restrictions, as describe in more detail with reference to FIGS. 19 to 22.

FIG. 19 illustrates an Add Default IP Restrictions method 1900 implemented with the security system 105, as shown in FIG. 2.

At step 1901, the method 1900 starts responsive to the user selecting the Default Settings/Default IP Addresses under Settings in the menu 301 in FIG. 3 to permit the user to set up global IP restrictions.

At step 1902, the security system 105 in FIG. 2 receives an IP address to be added, which is selected by the user from a list of IP addresses displayed in the IP Addresses box 1101 in FIG. 11.

At step 1903, the security system 105 in FIG. 2 determines whether the added IP address is a valid IP restriction. If the determination at step 1903 is positive, then the method 1900 continues to step 1905; otherwise, if the determination at step 1903 is negative, then the method 1600 continues to step 1904.

At step 1904, the security system 105 in FIG. 2 returns to step 1902 until the security system 105 receives a valid IP address or until the method 1900 is automatically or manually (e.g., by the user) cancelled.

At step 1905, the security system 105 in FIG. 2 receives an indication of user selection of the OK button 1106 in FIG. 11 to cause the security system 105 to accept the addition of the IP address to the list of IP restrictions.

FIG. 20 illustrates a Remove Default IP Restrictions method 2000 implemented with the security system 105, as shown in FIG. 2.

At step 2001, the method 2000 starts.

At step 2002, the security system 105 in FIG. 2 receives an IP address to be removed, which is selected by the user from a list of IP addresses displayed in the IP Addresses box 1101 in FIG. 11.

At step 2003, the security system 105 in FIG. 2 receives an indication of user selection of the Remove button 1103 in FIG. 11 to cause the security system 105 to delete the IP address from the list of IP restrictions.

At step 2004, the security system 105 in FIG. 2 receives an indication of user selection of the OK button 1106 in FIG. 11 to cause the security system 105 to accept the deletion of the IP address from the list of IP restrictions.

FIG. 21 illustrates an Enable Default IP Restrictions method 2100 implemented with the security system 105, as shown in FIG. 2.

At step 2101, the method 2100 starts.

At step 2102, the security system 105 in FIG. 2 receives an IP address to be enabled, which is selected by the user from a list of IP addresses displayed in the IP Addresses box 1101 in FIG. 11.

At step 2103, the security system 105 in FIG. 2 receives an indication of user selection of the Enable button 1105 in FIG. 11 to cause the security system 105 to enable the IP address from the list of IP restrictions.

At step 2104, the security system 105 in FIG. 2 receives an indication of user selection of the OK button 1106 in FIG. 11 to cause the security system 105 to accept the enabling of the IP address from the list of IP restrictions.

FIG. 22 illustrates an Edit Default IP Restrictions method 2200 implemented with the security system 105, as shown in FIG. 2.

At step 2201, the method 2200 starts.

At step 2202, the security system 105 in FIG. 2 receives an IP address to be edited, which is selected by the user from a list of IP addresses displayed in the IP Addresses box 1101.

At step 2203, the security system 105 in FIG. 2 receives an indication of user selection of the Edit button 1104 in FIG. 11 to cause the security system 105 to edit the IP address from the list of IP restrictions.

At step 2204, the security system 105 in FIG. 2 edits the IP address from the list of IP restrictions responsive to receiving user commands.

At step 2205, the security system 105 in FIG. 2 determines whether the edited IP address is a valid IP restriction. If the determination at step 2205 is positive, then the method 2200 continues to step 2207; otherwise, if the determination at step 2205 is negative, then the method 2200 continues to step 2206.

At step 2206, the security system 105 in FIG. 2 returns to step 2204 until the security system 105 receives a valid IP address or until the method 2200 is automatically or manually (e.g., by the user) cancelled.

At step 2207, the security system 105 in FIG. 2 receives an indication of user selection of the OK button 1106 in FIG. 11 to cause the security system 105 to accept the edit of the IP address to the list of IP restrictions.

E. Validating Connectivity to a Server

The security system 105 in FIG. 2 validates the connectivity to one or more servers. The connectivity validation is absolute in that there is either connectivity or there is no connectivity (e.g., Yes or No, a Boolean value (e.g. 1 or 0)). A user enables this function by selecting Validate Server Names from Settings in the menu 301 in FIG. 3, and a check mark appears next to the Validate Server Names menu item when enabled. Selecting the same menu item again disables the function, and no check mark appears next to the menu item. The security system 105 in FIG. 2 enables the validation function by default. The security system 105 in FIG. 2 validates any server that the user adds to the list of servers in the configuration to ensure that the connectivity to the server is valid. If the connectivity is not valid, the security system 105 in FIG. 2 displays the Connectivity Communication window 1200, as shown in FIG. 12. Validates the connectivity to one or more servers ensures that any problem with communication to one of the servers can be resolved before applying security to only some of the servers and/or avoids having the user experience intermittent communication problems.

F. Performing Connectivity Testing For A Server

The security system 105 in FIG. 2 in cooperation with the Connectivity Testing window 1300 in FIG. 13 performs connectivity testing to troubleshoot a connectivity problem with a particular server responsive to a connectivity problem indicated in the message 1201 in FIG. 12. The security system 105 permits a user to ping 1308 and trace routes 1307 to a particular server having a connectivity problem. For the trace routes, the user can specify the number of packets 1304, the characters per packet 1305, and request time out in seconds 1303, as well as time to live 1306.

The user may ping a server by performing the following steps. The user accesses the security management system window 300 in FIG. 3, and selects Connectivity Testing under one of the menus (e.g. Tools) in the menu 301 in FIG. 3 to cause the security system 105 in FIG. 2 to display the Connectivity Testing window 1300 in FIG. 13. The user enters either the host name of the server in the Host Name box 1301, or the IP address of the server in the IP address box 1302. Upon user selection of the Ping button 1308, the security system 105 in FIG. 2 transmits a test signal to the named server and waits for a reply test signal.

The user may trace a test signal to and/or from a server by performing the following steps. The user accesses the security management system window 300 in FIG. 3, and selects Connectivity Testing under one of the menus (e.g. Tools) in the menu 301 to cause the security system 105 in FIG. 2 to display the Connectivity Testing window 1300 in FIG. 13. The user enters either the host name of the server in the Host Name box 1301, or the IP address of the server in the IP address box 1302. The user may specify details of the trace routes by specifying the number of packets 1304, the characters per packet 1305, and request time out in seconds 1303, as well as time to live 1306. Upon user selection of the Trace button 1307, the security system 105 in FIG. 2 transmits a test signal to the named server and waits for a reply test signal.

G. Initializing a New Server

A user initializes a new server with a given set of configurations (i.e., replicating one server to another server), according to the method 2300 described in FIG. 23.

FIG. 23 illustrates an Initialize A New Server method 2300 implemented with the security system 105, as shown in FIG. 2.

At step 2301, the method 2300 starts by the user accessing the security management system window 300 in FIG. 3 and selects Initialize New server under one of the menus (e.g. Settings) in the menu 301 to cause the security system 105 in FIG. 2 to display the Initialize A Server window 1400 in FIG. 14.

At step 2302, the security system 105 in FIG. 2 receives the name of a server entered by the user in the Server Name box 1401.

At step 2303, the security system 105 in FIG. 2 determines whether the security system 105 is able to communicate with the named server. If the determination at step 2303 is positive, then the method 2300 continues to step 2305; otherwise, if the determination at step 2303 is negative, then the method 2300 continues to step 2304.

At step 2304, the security system 105 in FIG. 2 returns to step 2302 until the security system 105 receives a server name that the security system 105 can communicate with or until the method 2300 is automatically or manually (e.g., by the user) cancelled.

At step 2305, the security system 105 in FIG. 2 receives an indication of user selection of the either the Production Server check box 1402 or the Test Server check box 1403.

At step 2306, the security system 105 in FIG. 2 filters out hospitals (i.e., customers) for the server pool the new server belongs to.

At step 2307, the security system 105 in FIG. 2 applies RSA security and IP Security for each hospital in the filtered list.

At step 2308, the security system 105 in FIG. 2 receives an indication of user selection of the OK button 1404 in FIG. 14 to cause the security system 105 to associate the appropriate configuration files to the named server.

H. Refreshing Configuration Files After a Global Change

The user can re-run configuration files in the security system 105 in FIG. 2. The user employs the refresh function when making a global change to users (e.g., global IP change), or when engaging in disaster recovery, according to the method 2400 described in FIG. 24.

FIG. 24 illustrates a Refresh Servers method 2400 implemented with the security system 105, as shown in FIG. 2.

At step 2401, the method 2400 starts by the user accessing the security management system window 300 in FIG. 3 and selects Refresh Servers under one of the menus (e.g. Settings) in the menu 301 to cause the security system 105 in FIG. 2 to display the Refresh Servers window 1500 in FIG. 15.

At step 2402, the security system 105 in FIG. 2 determines whether the security system 105 should refresh of the servers responsive to an input (e.g., Yes button 1502 or No button 1503 in FIG. 15) from the user. If the determination at step 2402 is positive (e.g., the user selected the Yes button 1502), then the method 2400 continues to step 2403; otherwise, if the determination at step 2402 is negative (e.g., the user selected the No button 1503), then the method 2400 continues to step 2404.

At step 2403, the security system 105 in FIG. 2 applies RSA security and IP security for the hospital (i.e., customer) configurations.

At step 2404, the security system 105 in FIG. 2 does not apply RSA security and IP security for the hospital configurations.

1. Applying RSA Security to a Server.

FIG. 26 illustrates an RSA Security method 2600 implemented with the net access security system 105, as shown in FIG. 2. The RSA security tool 109 automates the setup and configuration of any customer that would use RSA Secure ID as their security mechanism. This system configures a virtual (and corresponding physical) directory across an enterprise from a central location. Any number of servers are configurable from a central location and may be configured the same or differently. Generally, the RSA security tool 109, using the method 2600, automatically performs the following steps:
1. Remotely creates the appropriate RSA Local groups on each server, which the RSA agent uses to authenticate them into the virtual directories.
2. Remotely assigns the local appropriate groups to their corresponding directories.
3. Scans a list of predefined servers to find which servers have the appropriate virtual directories to apply the RSA security to, and returns the physical path to apply the NTFS local groups to.
4. Configures the web servers with the appropriate RSA security settings.

More particularly, after the security system 105 retrieves the information to create the configuration data file, the security system 105 passes the information in the configuration data file to the RSA Security tool 109 to perform the following steps:
1. Verify connectivity to the specified servers.
2. Connect to the web servers on each of the servers specified via ADSI.
3. Validate that the virtual directory exists on each servers.
4. Get the physical path of each of the virtual directories.
5. Connect to each of the servers using ADSI to create the following local groups.
   a. SMS—if not already created.
   b. SMSadmin—if not already created.
   c. HHRR—where HHRR is the RSA/ACE group name.
   d. HHRRadmin—where HHRR is the RSA/ACE group name.
6. Connect to each server to verify the directory named “security” exists. If a security directory does not exist, the application creates the security directory, represented in a security command file, by copying the security command file (e.g., security.cmd) to the directory. The security command file has two parameters:
   a. High level directory to apply the security to.
   b. ACE/RSA local group name assigned to the hospital.

An example of the security.cmd file contains the following code, wherein %1 stands for 6a, and %2 stands for 6b described immediately herein above:
echo y|cacls %1\*.* /G Administrators:F Users:F SMS:F SMSadmin:F %2:F %2admin:F
echo y|cacls %1/G Administrators:F Users:F SMS:F SMSadmin:F %2:F %2admin:F
echo y|cacls % 1\appadmin\*.* /e /r %2/G Administrators:F Users:F SMS:F SMSadmin:F %2admin:F
echo y|cacls % 1\appadmin /e /r %2/G Administrators:F Users:F SMS:F SMSadmin:F %2admin:F
echo y|cacls %1\admin\*.* /e /r %2%2admin /G Administrators:F Users:F SMS:F SMSadmin:F
echo y|cacls % 1\admin /e /r %2%2admin /G Administrators:F Users:F SMS:F SMSadmin:F
   7. Communicate with each of the listed servers using WMI protocol to remotely execute the security.cmd file as if it was running locally on the server, by sending the security.cmd file including the parameters 6a and 6b listed above.
   8. Save the configuration information.
   9. Log any error codes to the security system 105, which updates the customer's data file with the information that was applied to the customers virtual and physical directories.

Referring to FIG. 26, at step 2601, the method 2600 starts. Users access the method 2600 from published desktops applications 105 (e.g. RSA security tool 109) on redundant terminal servers 103 located on the customer network. The physical data files are located on clustered files on the redundant file servers 104. Links are set up on the support desktops to launch the security system 105 from the location on the file servers 104.

At step 2602, the security system 105 in FIG. 2 receives inputs including, for example, the server list, the web site names, the virtual directory names, and the RSA group name (e.g., HHRR).

At step 2603, the security system 105 in FIG. 2 determines whether the security system 105 is able to communicate with one or more of the listed servers using the method 2600. If the determination at step 2603 is positive, then the method 2600 continues to step 2605; otherwise, if the determination at step 2603 is negative, then the method 2600 continues to step 2604.

At step 2604, the security system 105 in FIG. 2 notifies the user that the security system 105 is not able to communicate with one or more of the listed servers, and logs the message to a customer configuration file.

At step 2605, the security system 105 in FIG. 2 communicates (e.g., connects) with each listed server (e.g., using Active Directory Service Interface (ADSI)).

At step 2606, the security system 105 in FIG. 2 determines whether the virtual directories exist on the web server. If the determination at step 2606 is positive, then the method 2600 continues to step 2608; otherwise, if the determination at step 2606 is negative, then the method 2600 continues to step 2607.

At step 2607, the security system 105 in FIG. 2 logs an error message and continues to step 2615.

At step 2608, the security system 105 in FIG. 2 retrieves a virtual directory object (e.g., using ADSI) to determine the physical path between the security system 105 and the one or more listed servers.

At step 2609, the security system 105 in FIG. 2 creates local groups including HHRR, HHRRadmin, SMS, and SMSadmin, as described herein.

At step 2610, the security system 105 in FIG. 2 determines whether the SMS and SMSadmin exist in the local groups. If the determination at step 2610 is positive, then the method 2600 continues to step 2612; otherwise, if the determination at step 2610 is negative, then the method 2600 continues to step 2611.

At step 2611, the security system 105 in FIG. 2 creates local groups for the SMS and SMSadmin.

At step 2612, the security system 105 in FIG. 2 communicates (e.g., connects using Microsoft® windows management instrumentation (WMI)) to the remote computer and passes (e.g., using a “security.cmd”) parameters (i.e. properties) of the HHRR and the physical directory.

At step 2613, the security system 105 in FIG. 2 saves the record of the security properties 226 (i.e., configuration information) in FIG. 2 in the memory 202 (i.e., repository) in FIG. 2.

At step 2614, the security system 105 in FIG. 2 sets up (e.g., using ADSI) a virtual directory with the RSA secure ID configuration.

At step 2615, the security system 105 in FIG. 2 returns to the application that called the method 2600.

J. Applying IP Restrictions to a Server.

FIG. 27 illustrates an IP Security method 2700 implemented with the net access security manager, as shown in FIG. 2.

A security configuration and management system automates the setup and configuration of any user that desires to employ IP Address access restrictions. This system configures virtual directories across an organization from a central location. The system configures any number of servers from a central location in the same manner or a user selectable manner. Generally, the IP security tool 108, using the method 2700, automatically performs the following steps:
1. Scans a list of predefined servers to find which servers have the appropriate virtual directories to apply the IP Address security to.
2. Assigns the same IP address restrictions to the virtual directories.

More particularly, after the security system 105 retrieves the information to create the configuration data file, the security system 105 passes the information in the configuration data file to the IP security tool 108 to perform the following steps:
1. Verify connectivity to the specified servers.
2. Connect to the web servers on each of the servers specified via Active Directory Service Interface (ADSI).
3. Validate that the virtual directory exists on those servers.
4. Connect to the appropriate virtual directory object on each server.
5. Apply the appropriate IP address security restrictions to each of the virtual directories on the servers listed.
6. Save the configuration information.
7. Log any error codes to the security system 105, which updates the customers data file with the information that was applied to the customers virtual and physical directories.

Referring to FIG. 27, at step 2701, the method 2700 starts. Users access the method 2700 from a published desktops applications 105 (e.g. IP security tool 108) on redundant terminal servers 103 located on the customer network. The physical data files are located on clustered files on the redundant file servers 104. Links are set up on the support desktops to launch the security system 105 from the location on the file servers 104.

At step 2702, the security system 105 in FIG. 2 receives inputs including, for example, the server list, the web site names, the virtual directory names, IP addresses, and restrictions.

At step 2703, the security system 105 in FIG. 2 determines whether the security system 105 is able to communicate with one or more of the listed servers using the method 2700. If the determination at step 2703 is positive, then the method 2700 continues to step 2705; otherwise, if the determination at step 2703 is negative, then the method 2700 continues to step 2704.

At step 2704, the security system 105 in FIG. 2 notifies the user that the security system 105 is not able to communicate with one or more of the listed servers, and logs the message to a customer configuration file.

At step 2705, the security system 105 in FIG. 2 communicates (e.g., connects) with each listed server (e.g., using ADSI).

At step 2706, the security system 105 in FIG. 2 determines whether the virtual directories exist on the web server. If the determination at step 2706 is positive, then the method 2700 continues to step 2708; otherwise, if the determination at step 2706 is negative, then the method 2700 continues to step 2707.

At step 2707, the security system 105 in FIG. 2 logs an error message and continues to step 2715.

At step 2708, the security system 105 in FIG. 2 retrieves a virtual directory object (e.g., using ADSI) to determine the physical path between the security system 105 and the one or more listed servers.

At step 2709, the security system 105 in FIG. 2 applies the IP restrictions to each virtual directory.

At step 2710, the security system 105 in FIG. 2 saves the record of the security properties 226 (i.e., configuration information) in FIG. 2 in the memory 202 in FIG. 2.

At step 2711, the security system 105 in FIG. 2 returns to the application that called the method 2700.

Hence, while the present invention has been described with reference to various illustrative embodiments thereof, the present invention is not intended that the invention be limited to these specific embodiments. Those skilled in the art will recognize that variations, modifications, and combinations of the disclosed subject matter can be made without departing from the spirit and scope of the invention as set forth in the appended claims.

1. A centralized system for configuring security settings of a plurality of different processing devices via network communication, comprising:
a display generator for initiating generation of data representing a plurality of images including at least one image supporting user selection of data items including,
identifiers for identifying a plurality of different processing devices,
an identifier identifying a plurality of different websites hosted by a corresponding plurality of said different processing devices and
an identifier for identifying directories of said plurality of different websites;
a communication processor for establishing communication links with said plurality of different processing devices via a network; and
a configuration processor employing said communication links and said data items for initiating setting of security properties of said directories of said plurality of different websites, in response to user command.

2. A system according to claim 1, wherein
said at least one image supports user selection of security properties of said directories.

3. A system according to claim 2, wherein
said security properties of said directories restrict access to at least one of, (a) said directories and (b) an individual one of a plurality of documents identified in a directory.

4. A system according to claim 2, wherein
said security properties restrict access to at least one of, (a) a user at a particular Internet Protocol (IP) compatible address, (b) a user having an IP compatible address within a predetermined range of IP addresses and (c) a particular user within a predetermined group of users.

5. A system according to claim 1, wherein
said at least one image supports user selection of at least one of, (a) a name associated with configuration parameters of a particular user, (b) an identifier identifying a predetermined list of processing devices including said plurality of different processing devices and (c) said security properties.

6. A system according to claim 1, wherein
said plurality of different processing devices comprise at least one of, (a) a plurality of different servers, (b) a plurality of different computers, (c) a plurality of portable processing devices.

7. A system according to claim 1, wherein
said communication processor establishes said communication links using a secure communication protocol and
said secure server communication protocol includes at least one of, (a) Active Directory Service Interface (ADSI) compatible protocol, (b) Secure Socket Layer (SSL) compatible protocol, (c) Lightweight Directory Access Protocol (LDAP), (d) RSA-security compatible protocol and (e) Microsoft windows management instrumentation (WMI) compatible protocol.

8. A system according to claim 1, wherein
said configuration processor sets said security properties of said directory by at least one of, (a) replacing existing settings with new settings and (b) establishing new settings.

9. A system according to claim 1, wherein
a directory comprises an index identifying documents associated with a web site.

10. A system according to claim 1, wherein
said communication processor includes a security processor for initiating access to security settings associated with a directory using an identifier identifying a particular processing device of said plurality of different processing devices, an identifier identifying a particular website, of said plurality of different websites, hosted by said particular processing device and an identifier identifying a directory of said particular website and
said configuration processor stores a record of said set security properties of said directories.

11. A system according to claim 1, wherein
said data items received by said communication processor includes security settings comprising at least one of, (a) an Internet Protocol (IP) compatible address, (b) an identifier identifying a predetermined group of users, (c) an identifier identifying an individual user of a group of users and (d) a plurality of identifiers identifying a corresponding plurality of users associated with a particular group.

12. A system according to claim 1, wherein
said at least one image displays an alert message in response to at least one of, (a) a failure to establish a communication link with a particular processing device of said plurality of different processing devices, (b) a failure to identify a particular website, of said plurality of different websites, hosted by said particular processing device and (c) a failure to identify a directory of said particular website.

13. A system according to claim 1, wherein
said directories of said plurality of different websites are at least one of, (a) virtual directories and (b) physical file directories having a physical storage location.

14. A system according to claim 1, wherein
said at least one image supports user selection of data items including identifiers for identifying a plurality of different processing devices based on user selection of said plurality of different processing devices from at least one predetermined list of processing devices.

15. A system according to claim 1, wherein
said configuration processor employs said communication links and said data items for initiating setting of security properties of a particular directory of a particular website hosted by a particular processing device and including
a data processor for examining a predetermined list identifying websites and directories associated with corresponding processing devices to identify a processing device having said particular directory.

16. A centralized system for configuring security settings of a plurality of different processing devices via network communication, comprising:
a display generator for initiating generation of data representing a plurality of images including at least one image supporting user selection of data items including,
identifiers for identifying a plurality of different processing devices,
an identifier identifying a website hosted by at least one of said different processing devices and
an identifier for identifying a directory of said website;
a communication processor for establishing communication links with said plurality of different processing devices via a network; and
a configuration processor employing said communication links and said data items for setting security properties of said directory of said website hosted by said at least one said plurality of different processing devices, in response to user command.

17. A centralized system for configuring security settings of a plurality of different processing devices via network communication, comprising:
a display generator for initiating generation of data representing a plurality of images including at least one image supporting user selection of data items including,
identifiers for identifying a plurality of different processing devices,
an identifier identifying a plurality of different websites hosted by a corresponding plurality of said different processing devices and
an identifier for identifying directories of said plurality of different websites;
a communication processor for initiating communication with said plurality of different processing devices using a network in response to user command entered via said at least one image; and
a configuration processor employing said communication links and said data items, for initiating setting of security properties of said directories of said plurality of different websites hosted by said corresponding plurality of said different processing devices, in response to user command.

18. A system according to claim 17, including
a tracking processor for maintaining a record of at least one of, (a) user identifiers and (b) changes in security settings, supporting providing an audit trail identifying security setting changes and associated users.

19. A system according to claim 17, wherein
said configuration processor adaptively initiates setting of a plurality of different types of security properties of said directories by a corresponding plurality of different security setting processes.

20. A system according to claim 19, wherein
said plurality of different types of security properties at least one of, (a) restrict user access to a particular Internet Protocol (IP) compatible address or address range, (b) restrict user access to a user within a predetermined group of users and (c) restrict user access to a user within predetermined plurality of groups of users.

21. A system according to claim 20, wherein
said configuration processor employs RSA-security compatible protocol to restrict user access to a user within a predetermined group of users.

22. A system according to claim 17, wherein
said configuration processor sets security properties of said directories of said plurality of different websites hosted by said corresponding plurality of said different processing devices, to the same settings.

23. A system according to claim 17, wherein
said configuration processor sets security properties of said directories of said plurality of different websites hosted by said corresponding plurality of said different processing devices, to settings of a directory of a web site hosted by a particular processing device and imported from said particular processing device.

24. A system according to claim 17, wherein
said configuration processor uses a first communication protocol for establishing a path to said directory and uses a different second communication protocol for communicating setting information to said particular processing device.

25. A system according to claim 24, wherein
said first and second communication protocol comprise at least one of, (a) Active Directory Service Interface (ADSI) compatible protocol, (b) Secure Socket Layer (SSL) compatible protocol, (c) Lightweight Directory Access Protocol (LDAP), (d) RSA-security compatible protocol and (e) Microsoft windows management instrumentation (WMI) compatible protocol.

26. A system according to claim 17, wherein
said directory is at least one of, (a) a virtual directory and (b) a physical file directory having a physical storage location.

27. A system according to claim 17, wherein
said communication processor uses said secure communication link for determining an access path comprising at least one of, (a) a communication path and (b) an address of a physical stored file containing said directory.

28. A system according to claim 27, wherein
said configuration processor associates a label with said access path, said label identifying a group of users.

29. A method for configuring security settings of a plurality of different processing devices via network communication, comprising the activities of:
initiating generation of data representing a plurality of images including at least one image supporting user selection of data items including,
identifiers for identifying a plurality of different processing devices,
an identifier identifying a plurality of different websites hosted by a corresponding plurality of said different processing devices and
an identifier for identifying directories of said plurality of different websites;
establishing communication links with said plurality of different processing devices via a network; and
employing said communication links and said data items for initiating setting of security properties of said directories of said plurality of different websites, in response to user command.

30. A method for configuring security settings of a plurality of different processing devices via network communication, comprising the activities:
initiating generation of data representing a plurality of images including at least one image supporting user selection of data items including,
identifiers for identifying a plurality of different processing devices,
an identifier identifying a plurality of different websites hosted by a corresponding plurality of said different processing devices and
an identifier for identifying directories of said plurality of different websites;
initiating communication with said plurality of different processing devices using a network in response to user command entered via said at least one image; and
employing said communication links and said data items, for initiating setting of security properties of said directories of said plurality of different websites hosted by said corresponding plurality of said different processing devices, in response to user command.

31. A method for configuring security settings of a plurality of different processing devices via network communication, comprising the activities of:
initiating generation of data representing a plurality of images including at least one image supporting user selection of data items including,
identifiers for identifying a plurality of different processing devices,
an identifier identifying a website hosted by at least one of said different processing devices and
an identifier for identifying a directory of said website;
establishing communication links with said plurality of different processing devices via a network; and
employing said communication links and said data items for setting security properties of said directory of said website hosted by said at least one said plurality of different processing devices, in response to user command.
